(19) United States
(12) Patent Application Publication
(10) Pub. No.: US 2015/0206188 A1
(43) Pub. Date: Jul. 23, 2015

(54) ITEM PRESENTATION METHOD, AND INFORMATION DISPLAY METHOD

(71) Applicant: Panasonic Intellectual Property Corporation of America, Torrance, CA (US)

(72) Inventors: TORU TANIGAWA, Osaka (JP); MASAKI TAKAHASHI, Osaka (JP); KENTO OGAWA, Osaka (JP); KATSUFUMI INOUE, Osaka (JP)

(73) Assignee: Panasonic Intellectual Property Corporation of America, Torrance, CA (US)

(21) Appl. No.: 14/583,354

(22) Filed: Dec. 26, 2014

(30) Foreign Application Priority Data
Jan. 17, 2014 (JP) 2014-007105

(51) Int. Cl. G06Q 30/02; G06K 9/00; G06T 7/20

(52) U.S. Cl. CPC G06Q 30/0261; G06T 7/20; G06K 9/00369

(57) ABSTRACT

An item presentation system detects a movement of a customer in a store, and includes a presentation apparatus that performs the item presentation in the store based on detection results. The item presentation method of the item presentation system includes: detecting a first movement indicating that the customer enters a predetermined area around a product shelf; detecting a second movement indicating that the customer reaches out one hand to a first item as one of the items displayed on the product shelf; starting to count time from a moment that the second movement is detected if the second movement is detected after the first movement is detected; and causing the presentation apparatus to perform the item presentation on the item to which the customer reaches out the hand in the product shelf if the time counted becomes equal to a predetermined period of time.

### CROSS REFERENCES TO RELATED APPLICATIONS

This application claims priority to Japanese Patent Application No. 2014-007105, filed on Jan. 17, 2014, the contents of which are hereby incorporated by reference.

### BACKGROUND

1. Technical Field

The disclosure relates to a technique of merchandising at store level.

2. Description of the Related Art

Merchandising at the store level refers to a wide range of technique to promote sales. For example, merchandising may be performed by streamlining product lineup at a store in view of the best selling items and by reproducing an advertisement video on signage mounted on a product shelf or near a register in the store.

Since information related to items purchased by customers is managed by point of sales (POS) data in retail stores, it is easy to know the best selling item from slow-moving items. However, information of an item not purchased by customers is difficult to analyze based on the POS data.

Japanese Unexamined Patent Application Publication No. 2009-98929 discloses a technique that determines which item a customer is interested in. The disclosed technique performs quantitative measurements on items customers pick up in order to improve sales floor environment.

According to Japanese Unexamined Patent Application Publication No. 2009-98929, however, there is room for improvements.

### SUMMARY

In one general aspect, the techniques disclosed here feature a item presentation method of the item presentation system that detects a movement of a customer in a store, and includes a presentation apparatus performing the item presentation in the store based on detection results. The method includes: detecting a first movement indicating that a customer enters a predetermined area around a product shelf; detecting a second movement indicating that the customer reaches out one hand to a first item as one of the items displayed on the product shelf; starting to count time from a moment that the second movement is detected if the second movement is detected after the first movement is detected; and causing the presentation apparatus to perform the item presentation on the item to which the customer reaches out the hand in the product shelf if the time counted becomes equal to a predetermined period of time. These general and specific aspects may be implemented using a system, a method, and a computer program, and any combination of systems, methods, and computer programs.

With these aspects, further improvements are provided.

### BRIEF DESCRIPTION OF THE DRAWINGS

FIG. 1 is a functional block diagram of an item presentation system of a first embodiment;

FIG. 2 diagrammatically illustrates a store to which the item presentation system of the first embodiment is applicable;

FIG. 3A illustrates the layout of sensors of the item presentation system of the first embodiment;

FIG. 3B diagrammatically illustrates a pyroelectric sensor of the first embodiment;

FIG. 3C diagrammatically illustrates a laser range sensor of the first embodiment;

FIG. 4 diagrammatically illustrates a sensing area of the pyroelectric sensor of the item presentation system of the first embodiment;

FIG. 5 diagrammatically illustrates a sensing area of the pyroelectric sensor of the item presentation system of the first embodiment;

FIG. 6 diagrammatically illustrates the relationship between a customer in front of a product shelf and the sensing areas of the pyroelectric sensor and laser range sensor in the item presentation system of the first embodiment;

FIG. 7A illustrates a polar coordinate system with reference to the laser range sensor;

FIG. 7B illustrates a rectangular coordinate system with reference to the product shelf;

FIG. 8A illustrates storage contents of a person location history database of the first embodiment;

FIG. 8B illustrates storage contents of a person movement history database of the first embodiment;

FIG. 9A illustrates an occupation region of the product shelf of the first embodiment;

FIG. 9B illustrates storage contents of an item information database of the first embodiment;

FIG. 10 illustrates a specific example of item presentation with a lighting device of the first embodiment employed;

FIG. 11 illustrates a specific example of the item presentation with the lighting device of the first embodiment employed;

FIG. 12 illustrates a specific example of the item presentation with the lighting device of the first embodiment employed;

FIG. 13 illustrates a specific example of the item presentation with signage of the first embodiment employed;

FIG. 14 is a state transition chart of the item presentation system of the first embodiment;

FIG. 15 is a timechart illustrating an operation of the item presentation system of the first and second embodiments;

FIG. 16 is a flowchart illustrating an operation of the item presentation system of the first embodiment;

FIG. 17 is a functional block diagram illustrating the item presentation system of the second embodiment;

FIG. 18 illustrates storage contents of a related item database of the second embodiment;

FIG. 19 is a flowchart illustrating an operation of the item presentation system of the second embodiment;

FIG. 20 is a functional block diagram illustrating the item presentation system of a third embodiment;

FIG. 21A illustrates storage contents of a presentation history database of the third embodiment;

FIG. 21B illustrates storage contents of a sales database of a fourth embodiment;

FIG. 22 is an external view of store digital signage of the third embodiment;

FIG. 23 is a flowchart illustrating an operation of the item presentation performed using the store digital signage of the third embodiment;

FIG. 24 is a functional block diagram of the item presentation system of the fourth embodiment;

FIG. 25 diagrammatically illustrates a display of the fourth embodiment;

FIG. 26 illustrates a standard screen of the display of the fourth embodiment;

FIG. 27 illustrates an information display screen of the display of the fourth embodiment;

FIG. 28A illustrates a computer system (the item presentation system) implementing the item presentation;

FIG. 28B illustrates the computer system in which the computer of a device manufacturer serves as a data operation center;

FIG. 28C illustrates the computer system in which a computer of a device manufacturer and/or a management company serves as the data operation center;

FIG. 29 illustrates a network configuration of the item presentation system;

FIG. 30A illustrates an internal configuration of a cloud server;

FIG. 30B illustrates an internal configuration of an application;

FIG. 30C illustrates an internal configuration of a presentation section;

FIG. 31A illustrates a first service type (in-house data center type);

FIG. 31B illustrates a second service type (IaaS based type);

FIG. 31C illustrates a third service type (PaaS based type);

FIG. 31D illustrates a fourth service type (SaaS based type);

FIG. 32A illustrates a sequence in which a cloud server performs all processes 1 through 3;

FIG. 32B illustrates a sequence in which the presentation section performs the process 3 out of the processes 1 through 3; and

FIG. 32C illustrates a sequence in which the presentation section performs the processes 2 and 3 out of the processes 1 through 3.

### DETAILED DESCRIPTION

### Underlying Information of Disclosure

The inventor of the techniques has found out the following problems arising from the technique disclosed in Japanese Unexamined Patent Application Publication No. 2009-98929.

In order to stimulate new demand in the merchandizing at the store level, it is important to appeal to potential purchasers who may be difficult to know from sales data alone. The potential purchasers are customers who picked up an item from a product shelf in an indecisive attitude and finally decided not to purchase the item. However, item presentation, if performed on every customer who picks up and takes the item in his or her hand, is not effective. A customer who just picks up and takes an item does not necessarily mean a potential purchaser. Customer may have decided an item to purchase, or may have no choice but to purchase an item because no competitor's item is displayed, or may have been requested to purchase an item by their family member or a friend of theirs. In such a case, the customer who picks up the item is not a potential purchaser. If the item presentation is performed on all such customers, not only the item presentation becomes monotonous to the customers, but also no increase in sales quantity is expected. This may decrease the effectiveness of the item presentation on the potential purchasers.

The inventors have studied the following steps for improvement to address the above problem.

One aspect of the disclosure is related to a item presentation method of the item presentation system that detects a movement of a customer in a store, and includes a presentation apparatus performing the item presentation in the store based on detection results. The method includes: detecting a first movement indicating that the customer enters a predetermined area around a product shelf; detecting a second movement indicating that the customer reaches out one hand to a first item as one of the items displayed on the product shelf; starting to count time from a moment that the second movement is detected if the second movement is detected after the first movement is detected; and causing the presentation apparatus to perform the item presentation on the item to which the customer reaches out the hand in the product shelf if the time counted becomes equal to a predetermined period of time.

In this item presentation method, time counting is unfinished if a customer moves away from the product shelf soon after the customer approaches the product shelf and picks up an item displayed on the product shelf but returns the item. The item presentation is not performed on that customer. A customer may have decided to purchase an item in advance. In such a case, the customer may typically approach the product shelf, pick up the item and move away with the item from the product shelf. The item presentation is omitted on such a customer, and excessively performed item presentations are thus avoided. In this way, the item presentation using lighting effect and signage is prevented from becoming obsolete. On the other hand, a customer may approach a product shelf, pick up an item from the product shelf, and examine the item in front of the product shelf. When the time counted from when the customer reaches out his or her hand to the item to pick it up becomes equal to a predetermined period of time, the item presentation is performed. Another customer may pick up an item and examine a packet of the item, and may be still indecisive to purchase the item. Such a customer typically remains there until he or she finally decides whether to purchase the item or not. The customer who remains there after reaching out the hand to the item is presumed to be interested in the item. By performing the item presentation on such a customer, the targets of the item presentation are narrowed to customers who are much more interested in the item so that features of the item may be strongly appealing to such customers. Since the item is advertized only to the customer who are presumed to be interested in the item in front of the product shelf but to be still indecisive to purchase the item, the effectiveness of the item presentation is increased.

### EMBODIMENTS

Embodiments of the disclosure are described below with reference to the drawings.

### First Embodiment

### 1.1 Configuration of Item Presentation System

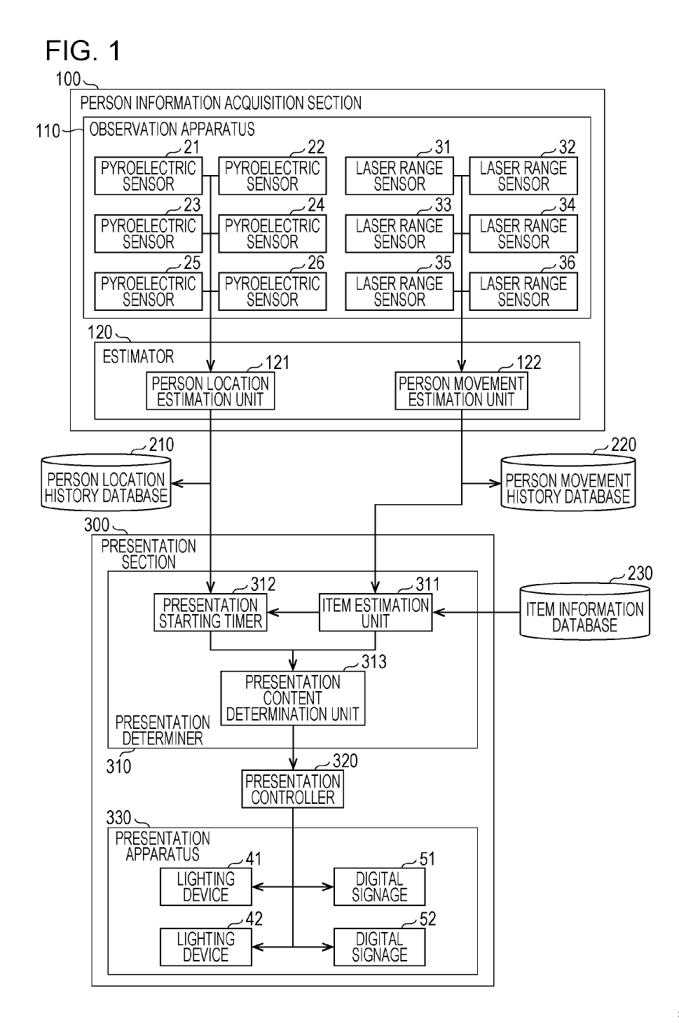

As illustrated in FIG. 1, an item presentation system includes person information acquisition section 100, person location history database 210, person movement history database 220, item information database 230, and presentation section 300.

The person information acquisition section 100 is mounted in a store and detects a movement of a customer coming into the store. The person information acquisition section 100 includes an observation apparatus 110, and an estimator 120 that estimates the movement of the customer based on detection contents detected by the observation apparatus 110.

The presentation section 300 performs item presentation based on the movement of the customer. The presentation section 300 includes a presentation determiner 310, a presentation controller 320, and a presentation apparatus 330. The presentation determiner 310 determines what presentation is to be performed based on the movement of the customer. The presentation apparatus 330 includes a lighting device and signage to perform presentation. The presentation controller 320 performs presentation by controlling the presentation apparatus 330 in accordance with the presentation content determined by the presentation determiner 310.

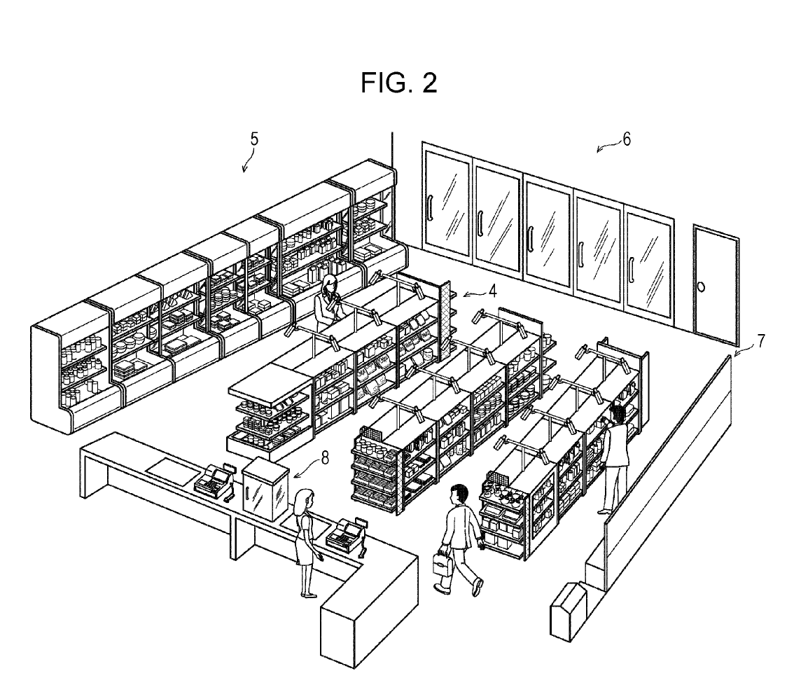

FIG. 2 is an internal view of the store. The store includes five types of product shelves, namely, a standard type product shelf 4, a low-temperature showcase type product shelf 5, a refrigerator type product shelf 6, a book-shelf type product shelf 7, and a constant temperature product shelf 8. These types of product shelves may be different from each other in terms of function and shape. A plurality of product shelves are vertically arranged in a product rack to store and display items. Each shelf includes a plurality of product storage bins arranged horizontally along each product shelf.

The standard type product shelf 4 has a front end and/or a back end facing a passage. In the store or the like, a plurality of product shelves are arranged in a longitudinal line. Each product shelf includes column members, beam members connected in perpendicular to the column members, and a plurality of shelf plates fixed on the beam members. The shelf plates form a product rack to store and display items. Each product shelf holds a plurality of product storage bins arranged horizontally.

The low-temperature showcase type product shelf 5 is used to display food items, such as rice balls, box lunches, salads, delicatessens, processed foods, milk, and milk-based drinks. The low-temperature showcase type product shelf 5 is formed in a display chamber having a front opening. The product rack and the product storage bin are formed in the display chamber. The display chamber includes a U-shaped heat-insulated wall having a front opening. A cooler and a duct are arranged behind the display chamber. A blower is arranged inside the duct, and air suctioned via a duct inlet port at the lower end of the duct is sent into the cooler. Cooled air from the cooler is discharged from an outlet port at the upper end of the duct in the display chamber, and sent to the items displayed on the product storage bins and product rack. In this way, the items on the display chamber are maintained at low temperature.

The refrigerator type product shelf 6 is a flush-mounted type product storage built into the wall of the store. The refrigerator type product shelf 6 is used to store frozen food, such as ice creams, and drinks, such as alcoholic beverages, coffee, tea, water, and juice. The product rack and the product storage bin are formed in such a product storage. The entire front surface of the product storage is closed by a single-hinged door. The single-hinged door is made of glass, and groceries at the front row in the product storage bin are seen through. The product storage bin of each product shelf in the product storage extends in a direction of depth, and a plurality of groceries is arranged in a column in the direction of depth so that a customer may take one by one.

The book-shelf type product shelf 7 extends laterally and is supported by a pair of poles, and is used to display magazines and books. A display counter for books for sale is supported by the poles in the front of the book-shelf type product shelf 7, and a sample display rack for book samples is supported on the back side of the book-shelf type product shelf 7 so that the sample books are vertically placed. A bookstall is arranged below the display counter to stack the books flat. The display counter, the sample display rack, and the bookstall form the product rack.

The constant temperature product shelf 8 is used to display fried foods, steamed meat buns, steamed bean-paste bun and the like. More specifically, the constant temperature product shelf 8 includes a plurality of display chambers, a hot-air circulating unit as an air-conditioning unit arranged below a display chamber, a cooling box arranged behind the hot-air circulating unit, and a refrigeration unit arranged below the hot-air circulating unit.

### 1.2 Configuration of Person Information Acquisition Section

The person information acquisition section 100 is described in detail below.

### (1) Observation Apparatus

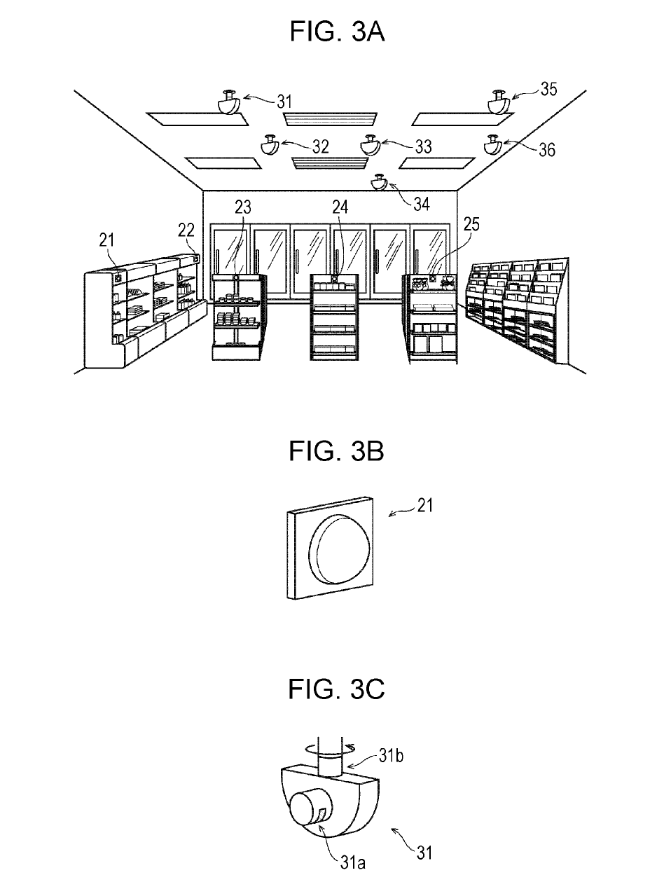

The observation apparatus 110 includes pyroelectric sensors 21 through 26 configured to detect whether a customer is present in front of each product shelf, and laser range sensors 31 through 36 configured to detect which item on the product shelf the customer reaches out the hand to. As illustrated in FIG. 3A, the pyroelectric sensors 21 through 26 are mounted on each product rack, and the laser range sensors 31 through 36 are mounted on the ceiling right above each product rack.

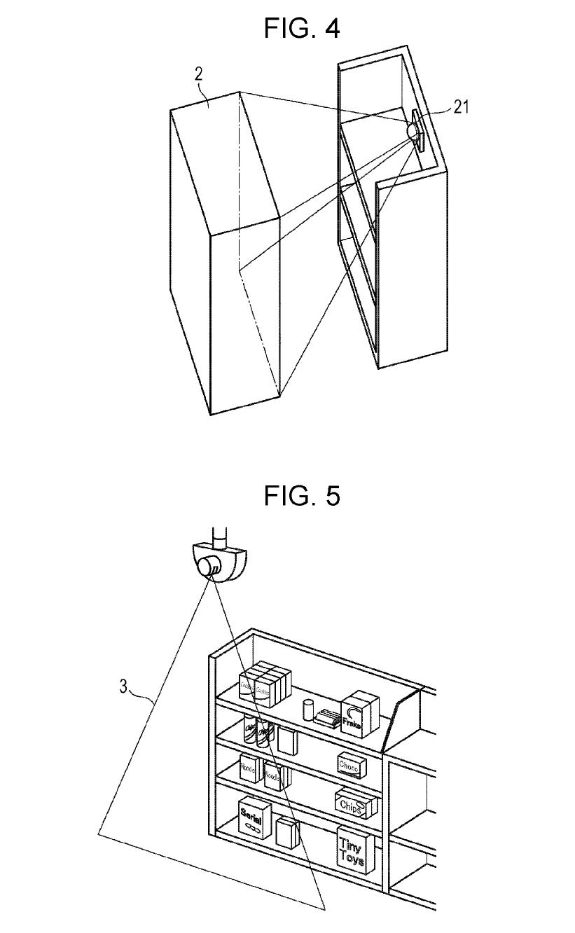

Referring to FIG. 3B, the pyroelectric sensor 21 detects whether a person is present by detecting infrared light emitted from the person. The pyroelectric sensor 21 includes an infrared sensor, a lens configured to define a detection area, and a low-pass filter (LPF) configured to block infrared light that is shorter in wavelength than the infrared light emitted from the body of the person. As illustrated in FIG. 4, the pyroelectric sensor 21 is mounted right above each product rack, and detects whether a customer is present within an area 2 in front of the product shelf. Referring to FIG. 4, the pyroelectric sensor 21 is mounted for the standard type product shelf 4. The pyroelectric sensor 21 may also be mounted in a similar fashion in the other types of product racks.

The laser range sensor 31 includes two semiconductor lasers different in wavelength, a sensor configured to measure a phase difference between emitted light and reflected light, and a prism configured to be rotated to emit infrared laser light and receive reflected laser light in a direction that varies along a lateral one-dimensional direction. As illustrated in FIG. 3C, the laser range sensor 31 rotates the prism to vary the angle thereof while emitting infrared laser light from a sensing part 31a in order to sense an area in front of the product shelf, and measures time from when the infrared laser light is emitted to when the reflected infrared light is received, based on the phase difference between the emitted laser light and reflected laser light. The laser range sensor 31 thus detects a range from the laser range sensor 31 to a point which the laser light is reflected from, and the direction to the point. As illustrated in FIG. 5, the laser range sensor 31 is mounted on the ceiling right above an area in front of the product rack. If part of the body, for example, a hand of the customer moves across an area 3 right in front of the product shelf, the laser range sensor 31 detects that location. A rotary shaft 31b is a moving part that performs adjustment so that the infrared laser light does not impinges on the product shelf.

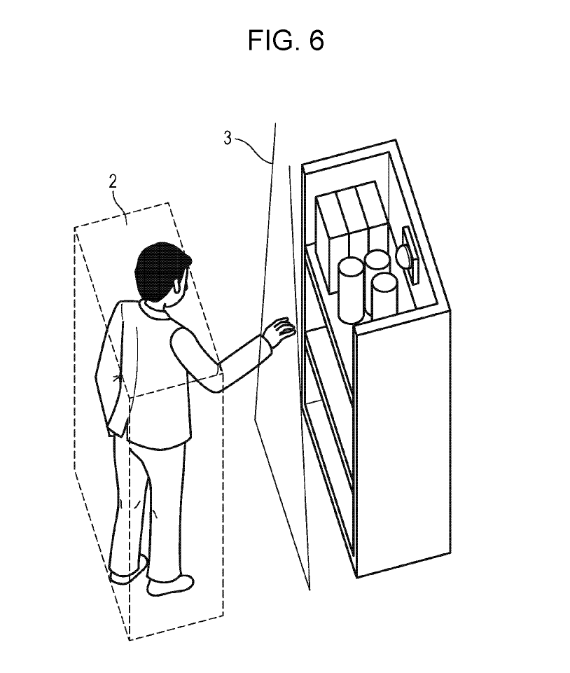

If a customer stops in front of the product rack as illustrated in FIG. 6, the customer is present within a space 2 in front of the product shelf. The pyroelectric sensor 21 thus detects the customer. If the customer reaches out the hand to an item displayed on the product shelf, the hand of the customer moves across the area 3 right in front of the product rack. The laser range sensor 31 thus detects the location of the hand of the customer.

The pyroelectric sensor 21 outputs to the person location estimation unit 121 in the estimator 120 a signal as to whether a customer has been detected or not. The laser range sensor 31 outputs a signal indicating the location of the hand of the customer to the person movement estimation unit 122 in the estimator 120.

### (2) Estimator

The estimator 120 estimates the movement of the customer from contents detected by the observation apparatus 110. The estimator 120 includes a person location estimation unit 121 and a person movement estimation unit 122. The person location estimation unit 121 estimates the presence of the customer in front of each product shelf. The person movement estimation unit 122 determines whether the customer reaches the hand to an item and estimates the location of the hand. The estimator 120 may be a computer, for example, and includes a microprocessor, a random-access memory (RAM), a read-only memory (ROM), a hard disk, and a network interface card (NIC). Each functional block of the estimator 120 may be implemented when the microprocessor executes a computer program stored on the RAM, the ROM, or the hard disk.

The person location estimation unit 121 receives outputs from the pyroelectric sensors 21 through 26, and then estimate the presence of customers in front of the product shelves. The pyroelectric sensor 21 may be mounted on a product shelf having a shelf identification (ID) 1, and may now detect an infrared light source. The person location estimation unit 121 determines that a customer is present in front of the product shelf having a shelf ID 1. Similarly, the pyroelectric sensor 23 mounted on the product shelf having a shelf ID 3 may detect no infrared light source. The person location estimation unit 121 thus determines that no customer is preset in front of the product shelf having a shelf ID 3. The person location estimation unit 121 outputs the information of the presence or absence of the customer at each product shelf together with the shelf ID at predetermined time intervals, for example, every second.

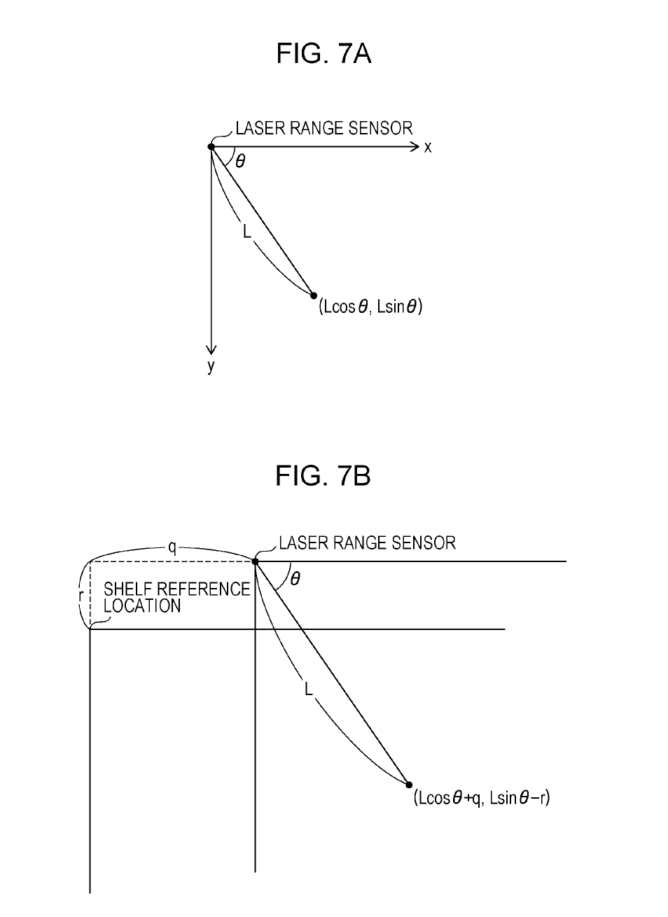

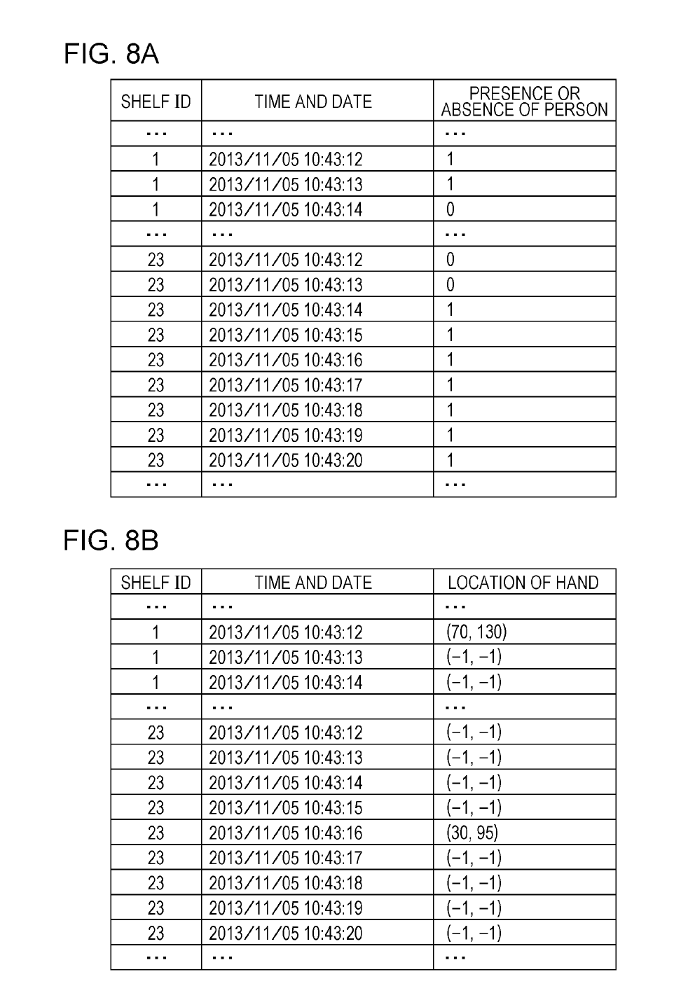

The person movement estimation unit 122 receives outputs from the laser range sensors 31 through 36 and estimate the location of the customer from the outputs. Referring to FIG. 7A, let θ represent a direction θ in which the reflected infrared laser light is detected, and L represent a range calculated from the phase difference between the emitted light and the reflected light, and the laser range sensor 31 outputs polar coordinates (L, θ) as a location from which the infrared laser beam is reflected with the position of the laser range sensor 31 as the origin. The person movement estimation unit 122 transforms the polar coordinates (L, θ) output from the laser range sensor 31 into coordinates (x, y) of a rectangular coordinate system having the product shelf as the origin, and the direction of height of the product shelf and the direction of width of the product shelf as the reference axes. The coordinate system with reference to the product shelf has the top left corner viewed from the front of the product shelf as the origin, and the direction of width (horizontal direction) as the x axis and the direction of height (vertical direction) as the y axis as illustrated in FIG. 8. Referring to FIG. 7B, the person movement estimation unit 122 stores coordinates (q, −r) of the laser range sensor 31 in the coordinate system with reference to the product shelf with respect to each combination of the product shelf and the laser range sensor 31. Coordinates of the location from which the infrared laser light beam is reflected are converted into (L cos θ+q, L sin θ−r) in accordance with the coordinates (q, −r) of the laser range sensor 31. The determined location is estimated as the location of the hand. If the customer does not reach his or her hand to a product shelf, the infrared laser light is directed to the floor and the resulting location is where no item is displayed. The person movement estimation unit 122 has the coordinate system with reference to the product shelf falling within the area where the items are displayed. If the converted coordinates are not included in the area, coordinates (−1, −1) indicating that data is out-of-area data and invalid are set to be the location of the hand.

The person movement estimation unit 122 outputs the estimated location of the hand together with the shelf ID of the corresponding product shelf at predetermined intervals, such as every second.

### 1.3 Structure of Databases

The structure of each of the person location history database 210, the person movement history database 220, and the item information database 230 is described below.

These databases may be a computer, for example, and includes a microprocessor, a random-access memory (RAM), a read-only memory (ROM), a hard disk, and an NIC. Each functional block of the database may be implemented when the microprocessor executes a computer program stored on the RAM, the ROM, or the hard disk. A single computer may implement a plurality of databases, for example, the person location history database 210 and the person movement history database 220.

The person location history database 210 receives the ID of the product shelf responsive to the presence or absence of the customer together with time from the person location estimation unit 121 in the estimator 120, stores the received contents, and then supplies the received contents to the presentation section 300. As illustrated in FIG. 8A, for example, the person location history database 210 stores the shelf ID, time and date, and the presence or absence of person. The presence or absence of person indicates whether a person is detected or not. More specifically, the state in which a customer is presumed to be present is indicated by “1”, and the state in which no customer is presumed to be present is indicated by “0”. More specifically, a record “shelf ID: 1, time: 2013/11/05 10:43:13, and detection result: 1” indicates that a customer is present in front of a product shelf having a shelf ID 1 at 10 o'clock 43 minutes 13 seconds, Nov. 5, 2013. Similarly, a record “shelf ID: 1, time: 2013/11/05 10:43:14, and detection result: 0” indicates that no customer is present in front of the product shelf having the shelf ID 1 at 10 o'clock 43 minutes 14 seconds, Nov. 5, 2013.

The person movement history database 220 receives from the person movement estimation unit 122 in the estimator 120 the shelf ID of the product shelf corresponding to the estimated location of the hand together with the time, stores the received information, and then supplies the information to the presentation section 300. Referring to FIG. 8B, the person movement history database 220 stores the shelf ID, the time, and the location of the hand. As described above, the location of the hand is coordinates in the rectangular coordinate system with reference to the corresponding product shelf. More specifically, a record “shelf ID: 23, time: 2013/11/05 10:43:16, and location of hand: (30, 95)” indicates that the customer reaches out the hand to location (30, 95) on a product shelf having a shelf ID 23 at 10 o'clock 43 minutes 16 seconds, Nov. 5, 2013. Similarly, a record “shelf ID: 23, time: 2013/11/05 10:43:17, and location of hand: (−1, −1)” indicates that no hand is detected on the product shelf having the shelf ID 23 at 10 o'clock 43 minutes 17 seconds, Nov. 5, 2013.

### 1.4 Configuration of Presentation Section

The presentation section 300 is described in detail.

### (1) Presentation Determiner

The presentation determiner 310 determines what presentation to perform based on the movement of the customer. The presentation determiner 310 includes an item estimation unit 311 configured to estimate the item to which the customer is presumed to reach out the hand, a presentation starting timer 312 configured to measure time from when the customer reaches the hand to the item displayed on the product shelf, and a presentation content determination unit 313 configured to determine the contents of the presentation. The presentation determiner 310 may be a computer, for example, and includes a microprocessor, a random-access memory (RAM), a read-only memory (ROM), a hard disk, and an NIC. Each functional block of the presentation determiner 310 may be implemented when the microprocessor executes a computer program stored on the RAM, the ROM, or the hard disk. The presentation determiner 310 may be implemented using hardware identical to that of the estimator 120.

The item estimation unit 311 receives a combination of the shelf ID, the time, and the location of the hand directly from the person movement estimation unit 122 or via the person movement history database 220. Using the item information database 230, the item estimation unit 311 estimates the item to which the customer has reached out the hand.

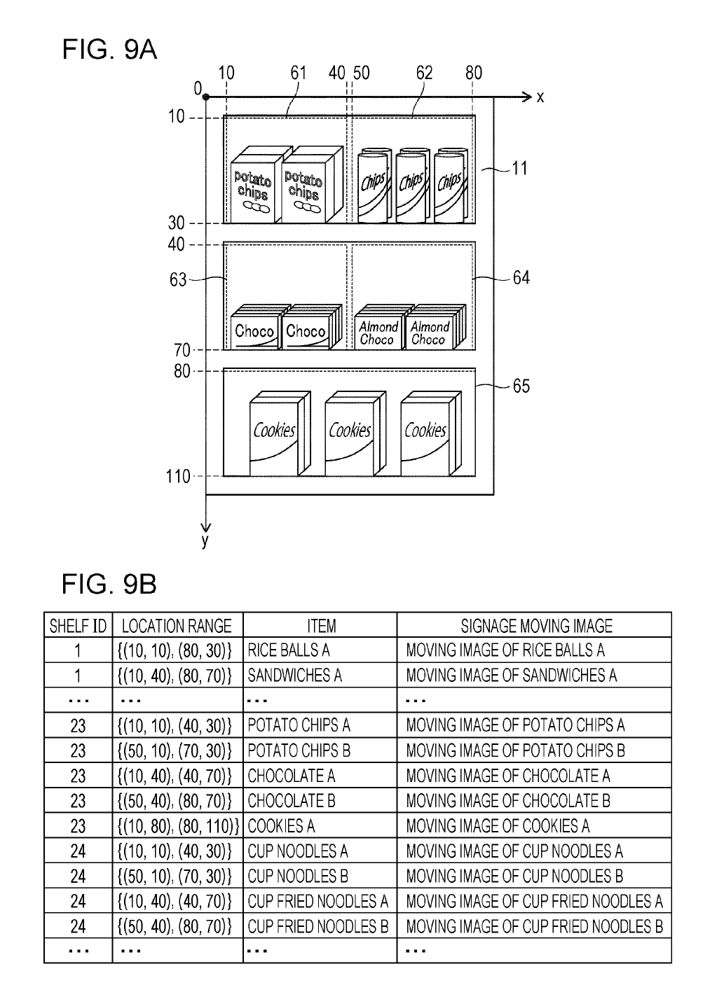

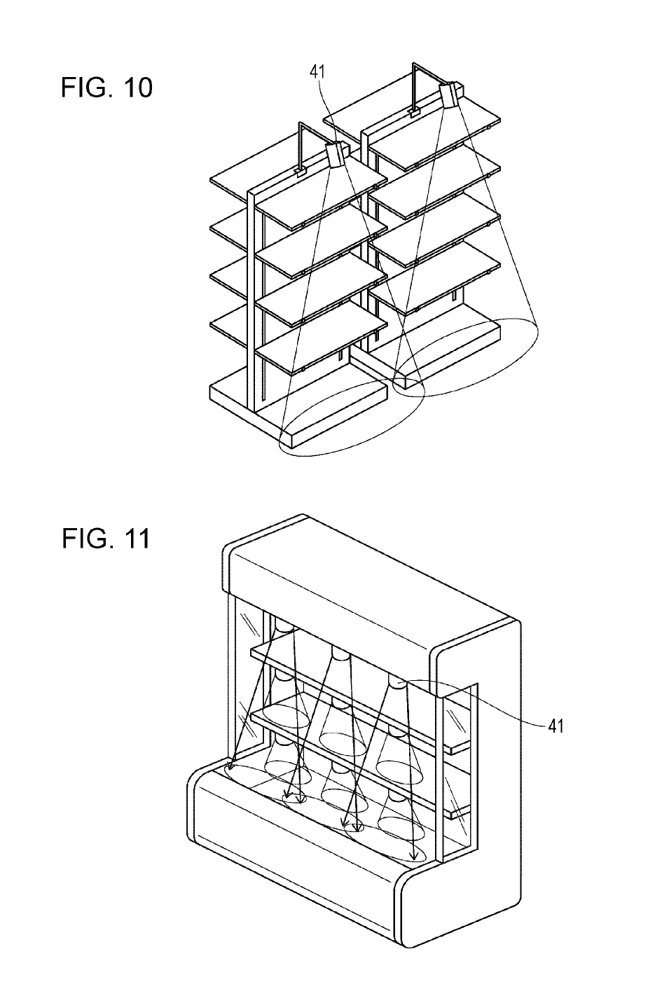

The estimation method of the item is described below with reference to FIG. 9A and FIG. 9B. FIG. 9A illustrates a display state of each item on the product shelf having a shelf ID 23, and a rectangular coordinate system having the product shelf as a reference. FIG. 9B illustrates the contents stored on the item information database 230. The item information database 230 stores the shelf ID, placement area, item, and signage moving image. The placement area refers to a rectangular area where the item is placed on the product shelf. The rectangular area is referenced with respect to the product shelf and defined by the top left corner and bottom right corner in the rectangular coordinate system. For example, [(10, 10), (40, 30)] indicates a rectangular area having a top left corner (10, 10), and a bottom left corner (40, 30), namely, indicates the rectangular area defined by four corners (10, 10), (10, 30), (40, 10), and (40, 30). As illustrated in FIG. 9A, the rectangular area corresponds to an area 61. The signage moving image refers to an advertisement moving image of an item that is reproduced on the digital signage 51 as a target of the item presentation. More specifically, a record “shelf ID: 23, placement area: [(50, 40), (80, 70)], item: chocolate B, and signage moving image: chocolate B moving image” indicates that the chocolate B is displayed in a rectangular area having four corners (50, 40), (50, 70), (80, 40), and (80, 70) on the product shelf having shelf ID 23, namely, in an area 64 of FIG. 9A. The record also indicates that the chocolate B moving image is used as an advertisement moving image when the advertisement moving image is delivered to the digital signage 51 with the chocolate B as a target of the item presentation. The item estimation unit 311 estimates that a customer has reached out the hand to cookies A on a product shelf having a shelf ID 23, based on a record “shelf ID: 23, time and date: 2013/11/05 10:43:16, and location of hand: (30, 95)”, and then decides to use a cookies A moving image as an advertisement moving image when the advertisement moving image is delivered to the digital signage 51 as a target of the item presentation. Upon receiving a valid location of the hand, namely, the location of the hand other than coordinates (−1, −1), the item estimation unit 311 outputs the estimated item and the moving image when the advertisement moving image is delivered to the digital signage 51. In the discussion that follows, receiving the valid location of the hand, namely, coordinates other than (−1, −1) is referred to as “detecting a second movement”.

The presentation starting timer 312 stores a predetermined period of time from when a customer reaches out the hand to an item displayed on the product shelf to when the item presentation starts. The predetermined period of time is 5 seconds, for example. The presentation starting timer 312 receives the information of the shelf ID, the time, and the presence or absence of person directly from the person location estimation unit 121 or via the person location history database 210, and manages each product shelf as to whether a customer is present in front of the product shelf. A state change from “0” to “1” about the presence of person is referred to “detecting a first movement”. The presentation starting timer 312 starts a timer operation by counting time when the item estimation unit 311 detects the second movement after detecting the first movement and outputs the advertisement moving image of the item to the digital signage 51. The presentation starting timer 312 also outputs information that the second movement has been detected. If the presence of person on the product shelf is changed in state from “1” to “0” (hereinafter referred to as a “third movement”) before the time counted on the presentation starting timer 312 becomes equal to the predetermined period of time, the presentation starting timer 312 stops counting. If the presentation starting timer 312 receives, from the item estimation unit 311 before the predetermined period time has elapsed, information that the customer reaches out the hand to an item different from the first item on the same product shelf at the start of time counting, the presentation starting timer 312 is defaulted to zero and then restarts counting. If the predetermined period of time has elapsed, the presentation starting timer 312 outputs a notification that the predetermined period of time has elapsed.

Upon receiving from the presentation starting timer 312 the notification that the timing counting has started, the presentation content determination unit 313 determines what presentation to perform in order to make the item appealing to the customer. This determination is performed based on the product shelf ID, and the signage moving image, corresponding to the item to which the customer has reached out the hand, and received from the item estimation unit 311. Upon receiving from the presentation starting timer 312 the notification that the timer operation has been complete, the presentation content determination unit 313 outputs the contents of the presentation to the presentation controller 320. The presentation content determination unit 313 reproduces the moving image on the signage in presentation on a per product shelf basis or on a per item basis. Alternatively, the presentation content determination unit 313 stores a predetermined control method of how to control illumination to present the product shelf, and thus controls the lighting device on the product shelf ID and the item. Alternatively, the presentation content determination unit 313 decides to reproduce the signage moving image on the digital signage 51. After the reception of the notification of the start of the timer operation from the presentation starting timer 312 but before the reception of the notification of the completed timer operation from the presentation starting timer 312, the presentation content determination unit 313 may receive from the item estimation unit 311 the notification that the customer reaches the hand to an item different from the first item on the product shelf having the same shelf ID. In such a case, the presentation content determination unit 313 discards the determined contents of the presentation, and determines what presentation to perform on the newly notified item. For example, before or after the reception of the notification of the start of the time counting, the presentation content determination unit 313 may receive a record “product shelf ID: 23, and item: chocolate A”, and may then receive a record “product shelf ID: 23, and item: chocolate B” before the reception of the notification of the completed timer operation. The presentation content determination unit 313 then discards the presentation contents related to the chocolate A, and then determines the presentation contents related to the chocolate B.

The presentation controller 320 controls the presentation apparatus 330 discussed later to perform the presentation determined by the presentation content determination unit 313. The presentation controller 320 may be implemented when a microprocessor in a computer executes a computer program stored on a RAM, a ROM, or a hard disk. The computer includes the microprocessor, the RAM, the ROM, the hard disk, and an interface configured to control the presentation apparatus 330.

The presentation apparatus 330 is mounted on the product shelf or the ceiling of the store, and includes lighting devices 41, 42, . . . configured to present part or whole of a particular product shelf, and digital signage 51, 52, . . . mounted on the product shelf or on the wall close to the product shelf and configured to reproduce the moving image.

### Description of Presentation Mode

The lighting device 41 is a light-emitting diode (LED) and is mounted on the upper portion of the product rack to illuminate the whole rack. The lighting device 41 is adjustable in brightness and color tone. More specifically, the lighting device 41 may be adjusted in brightness and color tone using a control parameter. The control parameters include a combination of brightness and color temperature, a combination of brightness and a right-green-blue (RGB) mixture ratio, and an RGB value.

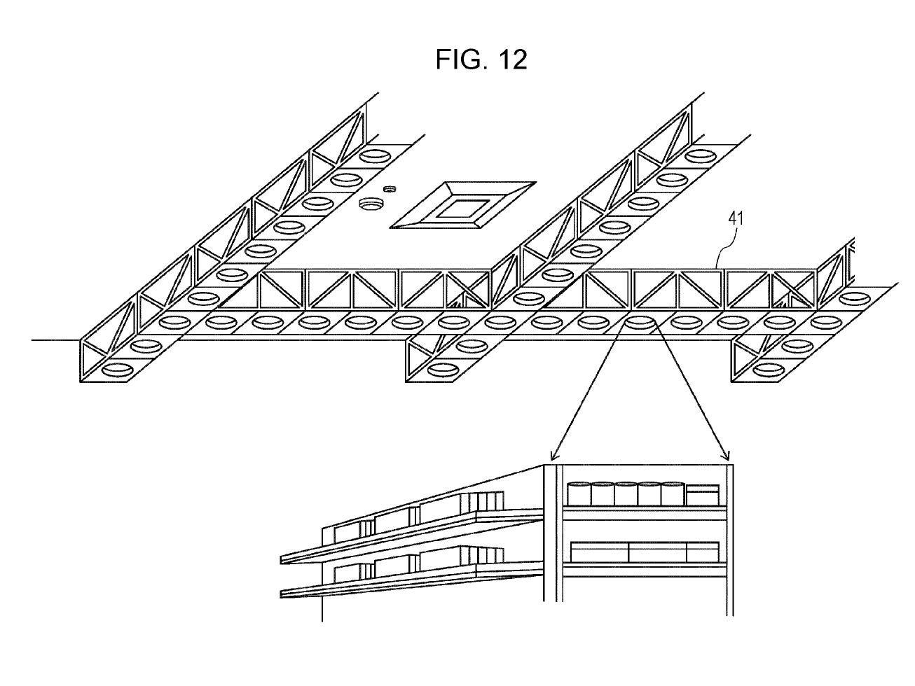

The lighting device 41 in another example may be mounted on the top board of the product shelf and may illuminate part or whole of a particular product shelf as illustrated in FIG. 11. The lighting device 41 may also be mounted on the ceiling of the store to illuminate a particular product shelf as illustrated in FIG. 12.

In the presentation using the lighting device, the lighting device 41 illuminates only an item storage bin holding items as a target of the presentation. Alternatively, for box lunches and delicatessens, which are supposed to be heated when or after payment is performed, the color temperature of the lighting device 41 is changed from a light bulb color of 3000K to a white color of 4200K so that a label on the item is clearly visible. These methods may be combined. For example, brightness or color temperature of the lighting device illuminating the entire product shelf displaying the items as a target of the presentation is reduced while the lighting device illuminating an item storage bin holding a particular item is turned on or the brightness level of the lighting device may be increased.

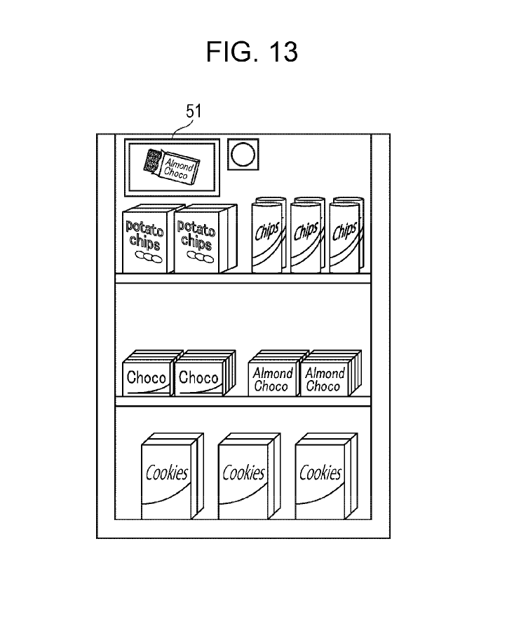

The digital signage 51 is mounted on the top portion of the product rack as illustrated in FIG. 13. The digital signage 51 includes a liquid-crystal display as large as about 5 inches and a loudspeaker. The digital signage 51 displays a moving image and outputs an audio signal, transmitted from a media server.

The presentation controller 320 controls the lighting device 41 in accordance with the presentation contents determined by the presentation content determination unit 313 to change the illumination or the color temperature of the lighting device 41. Alternatively, as a media server, the presentation controller 320 outputs moving image data to be reproduced on the digital signage 51, thus performing the determined presentation.

### 1.5 State Transition of Item Presentation System

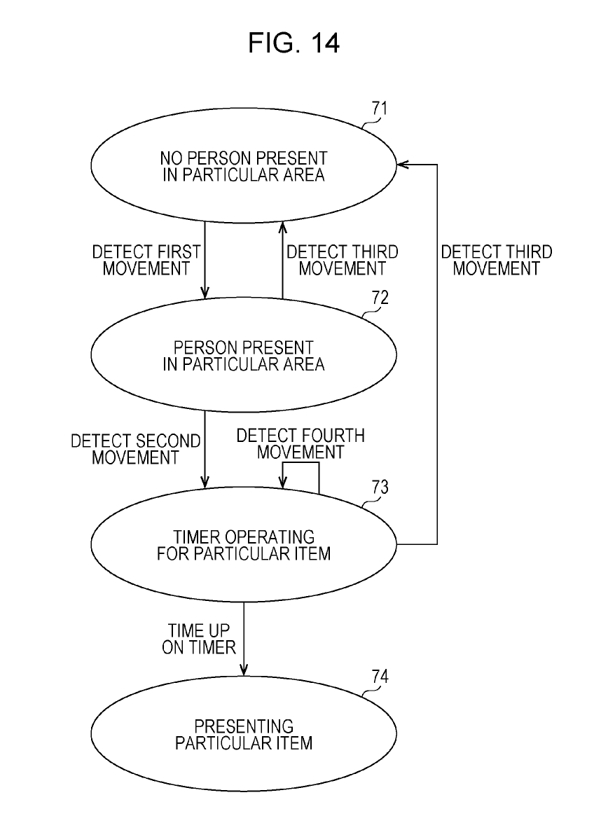

The operation of the item presentation system is described with reference to a state transition chart and a timechart. FIG. 14 is the state transition chart of each product shelf of the item presentation system. If no customer is detected in a particular area in front of the product shelf as a sensing area of the pyroelectric sensor 21, the item presentation system is in a state 71 in which no person is present in the particular area. If a customer comes into the particular area, the pyroelectric sensor 21 and the person location estimation unit 121 detect the first movement, and the item presentation system shifts to a state 72 in which a person is present within the particular area. If the person walks away from the particular area in the state 72 with a person present within the particular area, the pyroelectric sensor 21 and the person location estimation unit 121 detect a third movement. Since no customer is now present in the particular area, the item presentation system shifts back to the state 71 with no person present in the particular area.

If the second movement indicating that the customer reaches out the hand to an item displayed on the product shelf is detected in the state 72 with the person present in the particular area, information of the item is stored as a particular item and the timer operation starts. The item presentation system shifts to a timer operation state 73 for the particular item.

If the third movement indicating that the customer moves away from the particular area in the timer operation state 73 for the particular item is detected, the timer operation stops. The item presentation system shifts to the state 71 with no person in the particular area. If the customer moves away from the product shelf within a short period of time, that customer may be presumed not to be interested in the item displayed on the product shelf. The item presentation becomes less meaningful to that customer, and there is a possibility that the item presentation becomes monotonous to customers.

If a fourth movement indicating that the customer reaches the hand to another item, different from the item having triggered the second movement, on the same product shelf in the time operation state 73 for the particular item is detected, the information stored for the particular item is deleted, and the information for the other item to which the customer is determined to reach the hand later is stored as a particular item. The count at the timer is defaulted to zero, and the timer operation then restarts. The item presentation system shifts to the timer operation state 73 for the particular item. This is because if the customer picks up a plurality of items in succession, the customer may be determined not to be interested in the earlier item. The determination is to be made as to whether the customer is interested in the later item.

If the timer operation is complete without being interrupted in the timer operation state 73 for the particular product, the item presentation system shifts to an item presentation state 74 in which the item presentation of the particular item is performed. When the item presentation is complete, the item presentation system shifts to the state 71 with no person in the particular area.

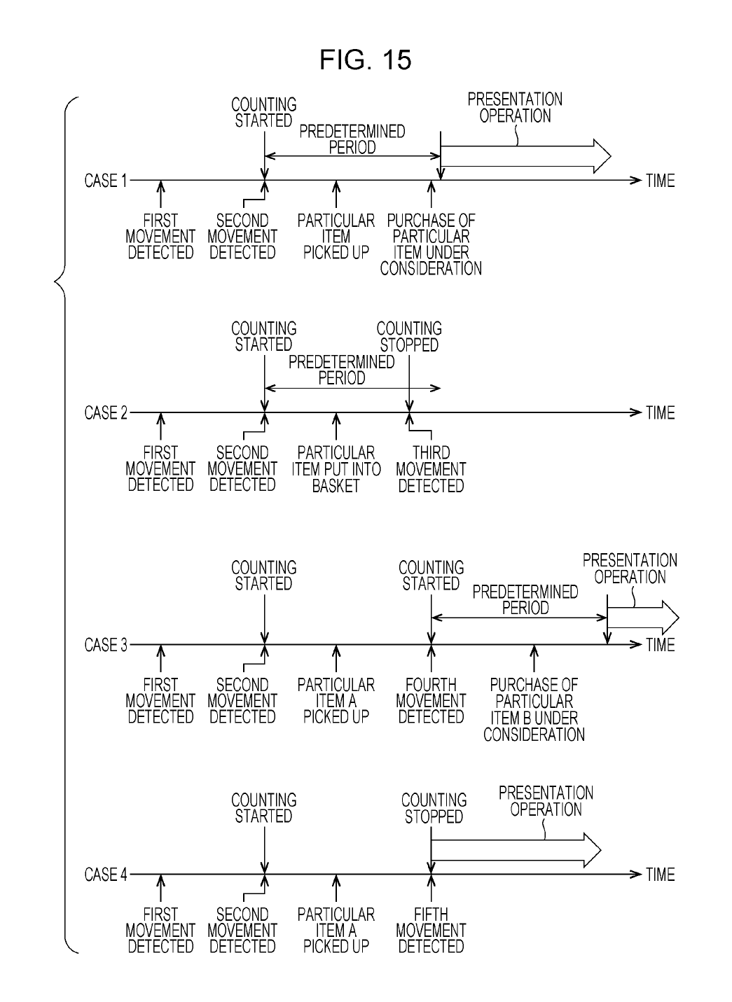

Possible operations are described with reference to a flowchart of FIG. 15.

Case 1 of FIG. 15 is described first. When a customer enters the particular area close to the front of a product shelf, the first movement is detected. If the second movement indicating that the customer reaches out the hand to an item on the product shelf is detected, the item determined to be reached by the customer is identified as a particular item. The presentation starting timer 312 is activated to count time. While the customer picks up and looks at the item to determine whether to purchase or not, he or she neither reaches out his or her hand to another item nor walks away from the product shelf. A predetermined period of time may elapse with neither the third movement nor the fourth movement detected. The presentation starting timer 312 thus completes the timer operation. The presentation apparatus 330 starts the item presentation on the particular item determined to be reached out by the customer's hand using the lighting device 41 and the digital signage 51. The customer thus views the presentation of the item he or she is currently considering purchasing. The item presentation system thus efficiently performs the presentation of the item, making the item appealing to the customer who now considers purchasing the item.

Case 2 of FIG. 15 is described. When a customer enters the particular area close to the front of a product shelf, the first movement is detected. If the second movement indicating that the customer reaches out the hand to an item on the product shelf is detected, the item determined to be reached by the customer's hand is identified as a particular item. The presentation starting timer 312 is activated to start the timer operation. If the customer picks up and puts the item into a shopping basket, and walks away from the product shelf. This means that the customer moves away from the particular area, the third movement is detected. If before the end of the timer operation the presentation starting timer 312 receives the notification that the third movement is detected, the presentation starting timer 312 ends the timer operation. The item presentation is not to be performed. The presentation apparatus 330 does not perform the item presentation. In this way, the item presentation is not performed if the customer moves away from the product shelf within a short period of time. This avoids performing the item presentation of an item frequently to customers who are not interested in the item so that the item presentation may not become monotonous to the customers. Case 2 is applied not only to the case that the customer reaches out the hand to the item, puts the item into the shopping basket, and moves away from the product shelf, but also to the case that the customer reaches out the hand to the item, but moves away from the product shelf even without picking up the item or moves away without putting the item into the basket even though the item is picked up.

Case 3 of FIG. 15 is described. When a customer enters the particular area close to the front of a product shelf, the first movement is detected. If the second movement indicating that the customer reaches out the hand to an item A on the product shelf is detected, the item determined to be reached by the customer is identified to be the item A as a particular item. The presentation starting timer 312 is activated to start the timer operation. If the customer reaches out the hand to another item B on the same product shelf after reaching out the hand to the item A and taking the item A, the fourth movement is detected. Upon receiving the notification of the detection of the fourth movement prior to the completion of the timer operation, the presentation starting timer 312 defaults back to zero and restarts the timer operation. The item estimation unit 311 determines the item B to be the particular item. The predetermined period of time may elapse with neither the third movement nor the fourth movement detected while the customer looks at the item B and considers purchasing it after taking the item B. The presentation starting timer 312 thus completes the timer operation. The presentation apparatus 330 starts the item presentation of the particular item B to which the customer presumably reaches out the hand to, using the lighting device 41 and the digital signage 51. The customer thus views the item presentation of the item which the customer consider purchasing. The item presentation system thus performs an efficient advertisement activity by setting the item to be appealing to the customer who is considering purchasing it.

### 1.6 Detailed Operation of Item Presentation System

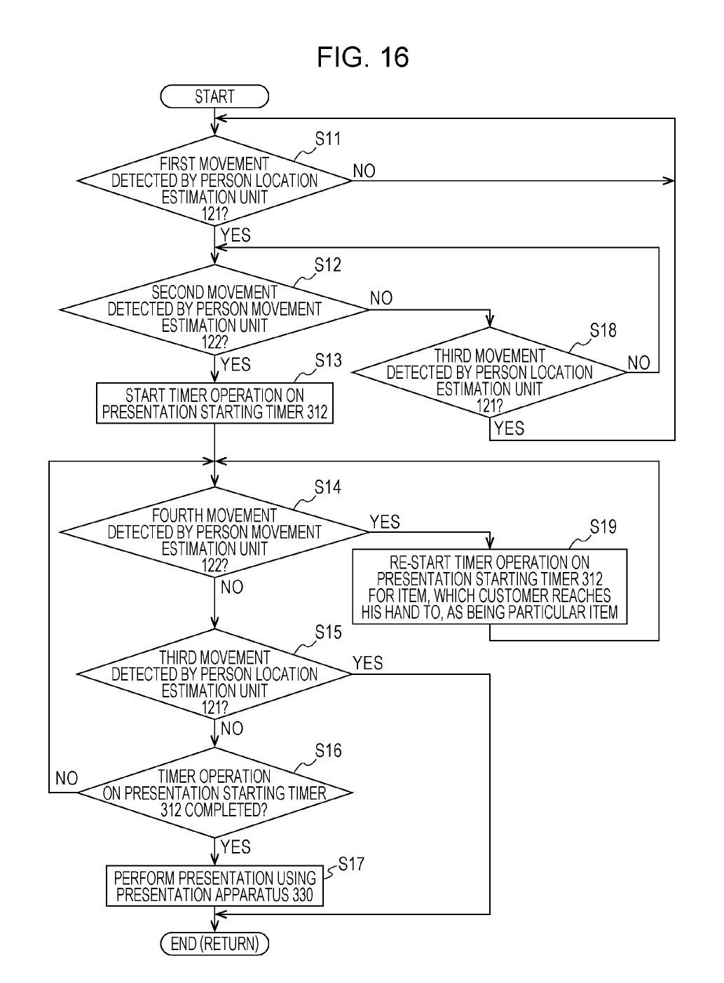

The operation of the item presentation system is described in detail with reference to a flowchart of FIG. 16.

The item presentation system monitors whether the person location estimation unit 121 has detected the first movement (S11). The item presentation system is now in the state 71 with no person present within the particular area. If the first movement is not detected (no branch from S11), the item presentation system performs the operation in S11 again to detect the first movement.

If the first movement is detected (yes branch from S11), the item presentation system uses the person movement estimation unit 122 to determine whether the second movement is detected (S12). The item presentation system is now in the state 72 with a person present within the particular area. If the second movement is not detected (no branch from S12), the item presentation system uses the person location estimation unit 121 to monitor whether the third movement is detected (S13). If the third movement is detected (yes branch from S13), the item presentation system returns to the state 71 with no person preset in the particular area, and then performs the operation in S11 again. If the third movement is not detected (no branch from S13), the item presentation system remains in the state 72 with a person present within the particular area, and thus performs the operation in S12 again.

If the second movement is detected (yes from S12), the item presentation system causes the presentation starting timer 312 to start the timer operation (S13). The item presentation system shifts to the timer operation state 73 with respect to the particular item.

Subsequent to S13, the item presentation system uses the person movement estimation unit 122 to monitor the fourth movement is detected (S14). If the fourth movement is detected (yes from S14), the item estimation unit 311 in the item presentation system estimates that the item the customer has newly reached out the hand is a particular item and causes the presentation starting timer 312 to default to zero and restart the timer operation (S19). The item presentation system changes the particular item from the earlier item to the new item, restarts the timer operation state 73 on the particular item, and performs the operation in S14 again.

If the fourth movement is not detected (no branch from S14), the item presentation system uses the person location estimation unit 121 to monitor the third movement is detected (S15). If the third movement is detected (yes from S15), the item presentation system causes the presentation starting timer 312 to stop counting. The item presentation system returns to the state 71 with no person present in the particular area, and performs the operation in S11 again.

If the third movement is not detected (no branch from S15), the item presentation system determines whether the presentation starting timer 312 has completed the timer operation (S16). If the presentation starting timer 312 has not completed the timer operation yet (no branch from S16), the item presentation system performs the operation in S14 again. If the presentation starting timer 312 has completed the timer operation (yes branch from S16), the item presentation system performs the presentation of the particular item using the presentation apparatus 330 in response to an instruction from the presentation controller 320 (S17). The item presentation system shifts to the presentation operation state 74 on the particular item. Upon completing the item presentation, the item presentation system shifts to the state 71 with no person within the particular area, and performs the operation in S11 again.

### 1.7 Summary

As described above, the item presentation system monitors whether a customer is present in front of a product shelf or not, and monitors which item on a product shelf the customer reaches out the hand to. Based on the monitoring results, the item presentation system selects only customers who presumably show interest in the item but are still undecided as to whether to purchase the item or not and makes the item more appealing to the selected customers. By narrowing the target customers in this way, the effectiveness of the item presentation is increased. By not performing the item presentation to customers who are not interested in items, the item presentation is saved from becoming monotonous.

### Second Embodiment

In a second embodiment, the item as a target of the item presentation is changed depending on the movement of the customer.

Elements identical to those in the first embodiment are designated with the same reference numerals, and operations identical to those in the first embodiment are designated with the same step numbers.

### 2.1 Configuration of Item Presentation System

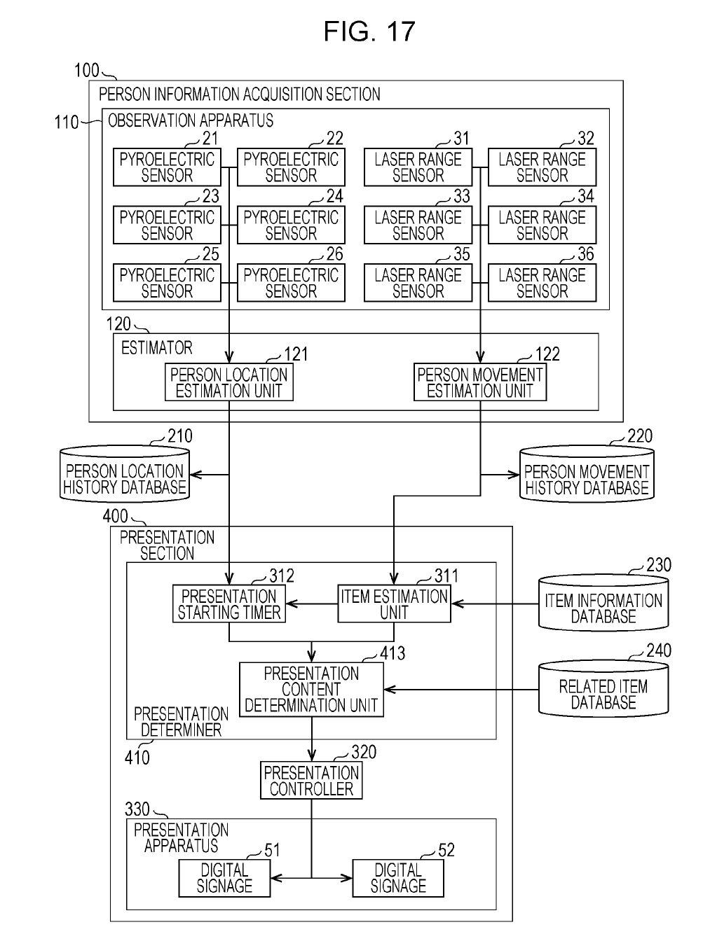

As illustrated in FIG. 17, the item presentation system of the second embodiment includes person information acquisition section 100, person location history database 210, person movement history database 220, item information database 230, related item database 240, and presentation section 400.

### 2.2 Related Item Database

The related item database 240 is identical in hardware configuration to other database, and the discussion thereof is omitted herein. Contents of the related item database 240 are described below.

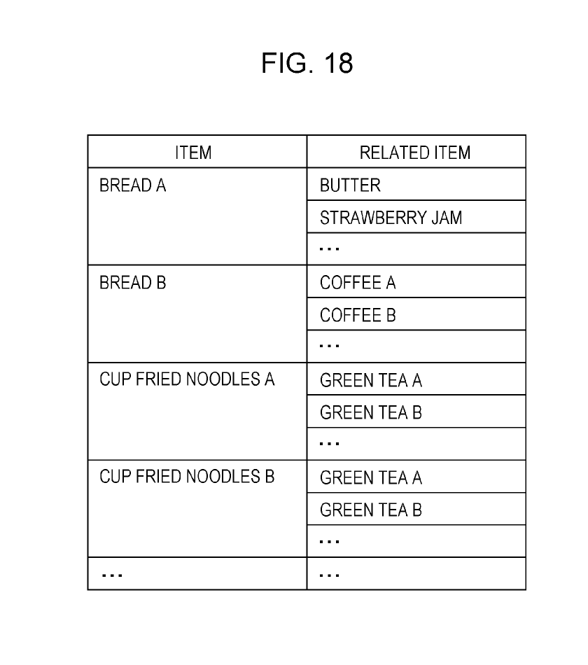

As illustrated in FIG. 18, the related item database 240 stores information of a combination of a first item and an item related the first item. The related item is an item the customer is likely to purchase together when he or she has purchased the first item. For example, a record “item: bread A, related item: butter, and strawberry jam” indicates that a customer who has purchased the bread A is likely to purchase butter and strawberry jam together with the bread A. The combination of the item and the related item is not limited to a relatively close relationship, such as a combination of bread and butter and jam. Any combination is acceptable as long as the combination has a correlation in sales data, such as a combination of a box lunch, cup noodles, and green tea, or a combination of bread, coffee, and tea. The related item database 240 stores a correlation of items, and a combination that is derived from sales data.

### 2.3 Configuration of Presentation Section

The presentation section 400 is identical in configuration to the presentation section 300 except the following points. The presentation section 400 includes the presentation apparatus 330 that includes signage 51, 52, . . . , but does not include the lighting devices 41, 42, . . . . The presentation section 400 also includes a presentation content determination unit 413 in place of the presentation content determination unit 313.

As the presentation content determination unit 313, the presentation content determination unit 413 receives the notification of the start of the timer operation from the presentation starting timer 312. Upon receiving from the presentation starting timer 312 the notification that the timing counting has started, the presentation content determination unit 413 determines what presentation to perform in order to make the item appealing to the customer. This determination is performed based on the product shelf ID, and the signage moving image, corresponding to the item to which the customer has reached out the hand, and received from the item estimation unit 311. Upon receiving from the presentation starting timer 312 the notification that the time counting has been complete, the presentation content determination unit 413 outputs the contents of the presentation to the presentation controller 320. After the reception of the notification of the start of the timer operation from the presentation starting timer 312 but before the reception of the notification of the completed timer operation from the presentation starting timer 312, the presentation content determination unit 413 may receive from the item estimation unit 311 the notification that the customer reaches the hand to an item different from the first item on the product shelf having the same shelf ID. In such a case, the presentation content determination unit 413 discards the determined contents of the presentation, and determines what presentation to perform on the newly notified item. After the reception of the notification of the start of the timer operation from the presentation starting timer 312 but before the reception of the notification of the completed timer operation from the presentation starting timer 312, the presentation content determination unit 413 may receive from the item estimation unit 311 a plurality of notifications that the customer reaches the hand to the same item on the same product shelf. In such a case, the presentation content determination unit 413 discards the determined contents of presentation. The presentation content determination unit 413 receives from the related item database 240 the information of the related item corresponding to the item received from the item estimation unit 311. The presentation content determination unit 413 determines the contents of presentation for the related item, namely, the moving image presenting the related item, which is to be reproduced on the digital signage 51 mounted on the product shelf having the shelf ID acquired from the item estimation unit 311. Without waiting for the completion of the timer operation of the presentation starting timer 312, the presentation content determination unit 413 outputs the contents of presentation for the related item to the presentation controller 320. If there is a plurality of related items corresponding to a single item, one item may be selected from green tea A, green tea B, green tea C, . . . , in that order for example. Alternatively, any one item may be selected by generating a random number. Alternatively, the related item database 240 may store the degree of priority for each of the related items, and each related item may be used in high to low priority order.

A record “product shelf ID: 24, and item: cup fried noodles A” may now be received before or after the reception of the notification of the start of the timer operation, and a record “product shelf ID: 24, and item: green tea A” may be received before the reception of the notification of the completed timer operation. In such a case, the contents of the presentation related to the cup fried noodles A are discarded. The presentation content determination unit 413 thus determines the contents of the presentation related to the green tea A as the related item.

### 2.4 Summary of Operation of Item Presentation System

The operation of the item presentation system is described with reference to a timechart of case 4 of FIG. 15.

When a customer enters the particular area close to the front of a product shelf, the first movement is detected. If the second movement indicating that the customer reaches out the hand to an item on the product shelf is detected, the item determined to be reached by the customer is identified as a particular item. The presentation starting timer 312 is activated to count time. The customer picks up, and looks at the item to determine whether to purchase or not. If the customer reaches out the hand to the same item again, a fifth movement indicating that the customer reaches out the hand to the same item as in the second movement is detected. During a period from the reception of the start of the timer operation to the reception of the completion of the timer operation by the presentation starting timer 312, the presentation content determination unit 413 receives two or more notifications that the customer reaches out the hand to the same item on the same product shelf, and determines the presentation for the related item. Without waiting for the reception of the completion of timer operation by the presentation starting timer 312, the presentation content determination unit 413 gives an instruction to perform the item presentation. The presentation apparatus 330 starts the presentation for the item related to the particular item determined to be reached by the customer's hand, using the digital signage 51. The customer thus views the presentation of the item related to the item that is interesting enough for the customer to reach out the hand to. The item presentation system may thus efficiently advertise a set of related items, by making the related items appealing to the customer who is strongly interested in the item.

### 2.5 Detailed Operation of Item Presentation System

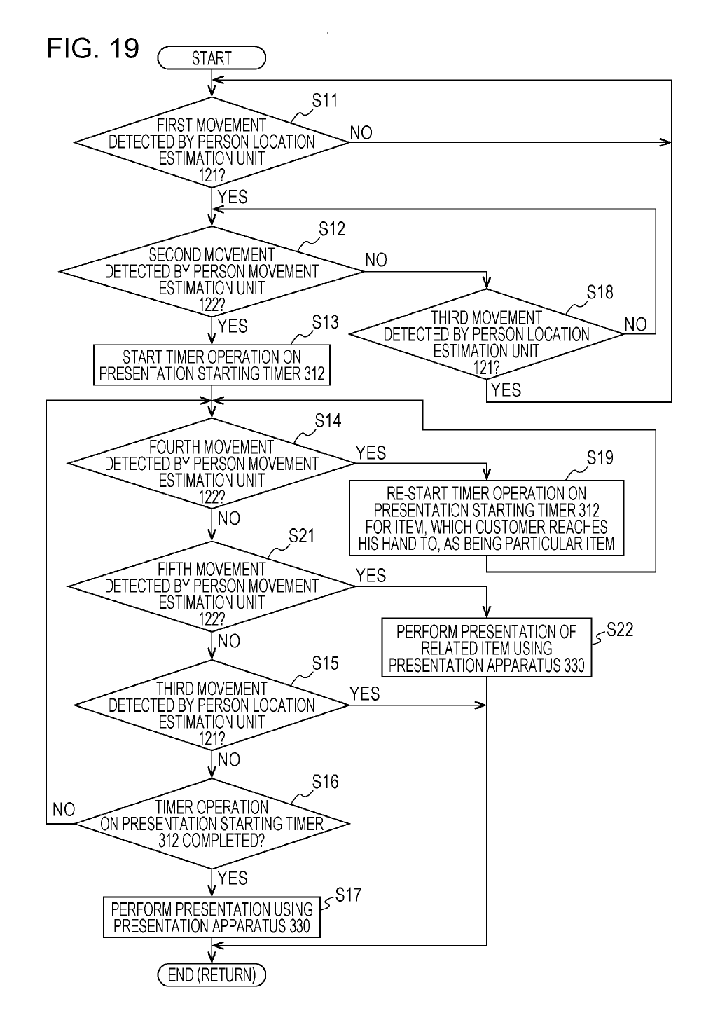

The detailed operation of the item presentation system is described with reference to a flowchart of FIG. 19.

The item presentation system uses the person location estimation unit 121 to monitor whether the first movement is detected (S11). The item presentation system is now in the state 71 in which no person is present within the particular area. If the first movement is not detected (no branch from S11), the item presentation system performs the operation in S11 again to detect the first movement.

If the first movement is detected (yes branch from S11), the item presentation system uses the person movement estimation unit 122 to determine whether the second movement is detected (S12). The item presentation system is now in the state 72 in which a person is within the particular area. If the second movement is not detected (no branch from S12), the item presentation system uses the person location estimation unit 121 to monitor whether the third movement is detected (S13). If the third movement is detected (yes branch from S13), the item presentation system returns to the state 71 in which no person is preset in the particular area, and then performs the operation in S11 again. If the third movement is not detected (no branch from S13), the item presentation system remains in the state 72 in which the person is within the particular area, and thus performs the operation in S12 again.

If the second movement is detected (yes from S12), the item presentation system causes the presentation starting timer 312 to start the timer operation (S13). The item presentation system shifts to the timer operation state 73.

Subsequent to S13, the item presentation system uses the person movement estimation unit 122 to monitor whether the fourth movement is detected (S14). If the fourth movement has been detected (yes from S14), the item estimation unit 311 in the item presentation system estimates that the item the customer has reached out the hand is a particular item and causes the presentation starting timer 312 to default to zero and restart the timer operation (S19). The item presentation system changes the particular item to the new item, restarts the timer operation state 73 on the particular item, and performs the operation in S14 again.

If the fourth movement has not been detected (no branch from S14), the item presentation system uses the person movement estimation unit 122 to monitor whether the fifth movement has been detected (S21). If the fifth movement has been detected (yes branch from S21), the item presentation system acquires from the related item database 240 information about an item, related to a particular item. The presentation content determination unit 413 determines as the particular item an item that the customer has reached out the hand to. The item presentation system immediately starts the presentation of the related item using the digital signage 51 of the product shelf on which the particular item is displayed. Subsequent to the item presentation, the item presentation system returns to the state 71 with no person present within the particular area, and performs the operation S11 again.

If the fifth movement has not been detected (no branch from S21), the item presentation system uses the person location estimation unit 121 to monitor whether the third movement is detected (S15). If the third movement is detected (yes from S15), the item presentation system causes the presentation starting timer 312 to stop the timer operation. The item presentation system returns to the state 71 with no person present in the particular area, and performs the operation in S11 again.

If the third movement is not detected (no branch from S15), the item presentation system determines whether the presentation starting timer 312 has completed the timer operation (S16). If the presentation starting timer 312 has not completed the timer operation yet (no branch from S16), the item presentation system performs the operation in S14 again. If the presentation starting timer 312 has completed the timer operation (yes branch from S16), the item presentation system performs the presentation of the particular item using the presentation apparatus 330 in response to an instruction from the presentation controller 320 (S17). The item presentation system shifts to the presentation operation state 74 on the particular item, and then shifts to the state 71 with no person within the particular area, and performs the operation in S11 again.

### 2.6 Summary

If the customer reaches out the hand to the same item by multiple times, the item presentation system performs the item presentation on the related item rather than the original item itself. In this way, the item presentation system performs an efficient advertisement by focusing on customers who are interested in an item and by making a recommendable set of related items appealing to the interested customers.

### Third Embodiment

In a third embodiment, another item presentation is performed based on a history of item presentation.

Elements identical to those in the first and second embodiments are designated with the same reference numerals, operations identical to those in the first and second embodiments are designated with the same operation numbers, and the discussion thereof is omitted herein.

### 3.1 Configuration of Item Presentation System

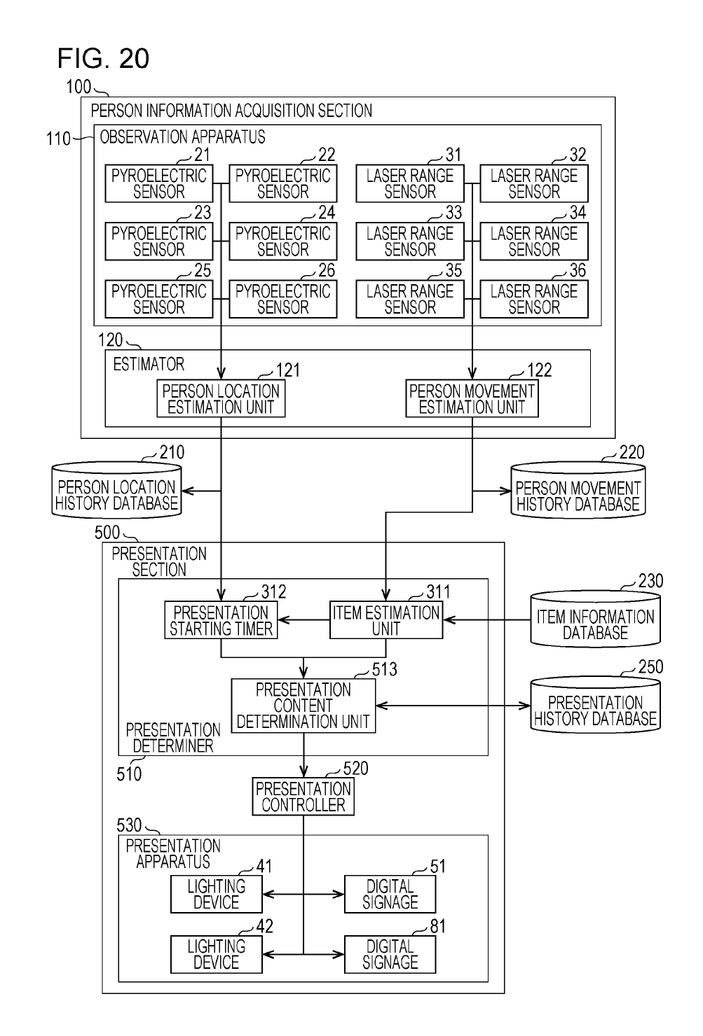

As illustrated in FIG. 20, the item presentation system of the third embodiment includes person information acquisition section 100, person location history database 210, person movement history database 220, item information database 230, presentation history database 250, and presentation section 500.

### 3.2 Presentation History Database

The presentation history database 250 is identical in hardware configuration to the other databases, and the discussion thereof is omitted. The contents of the presentation history database 250 are described below.

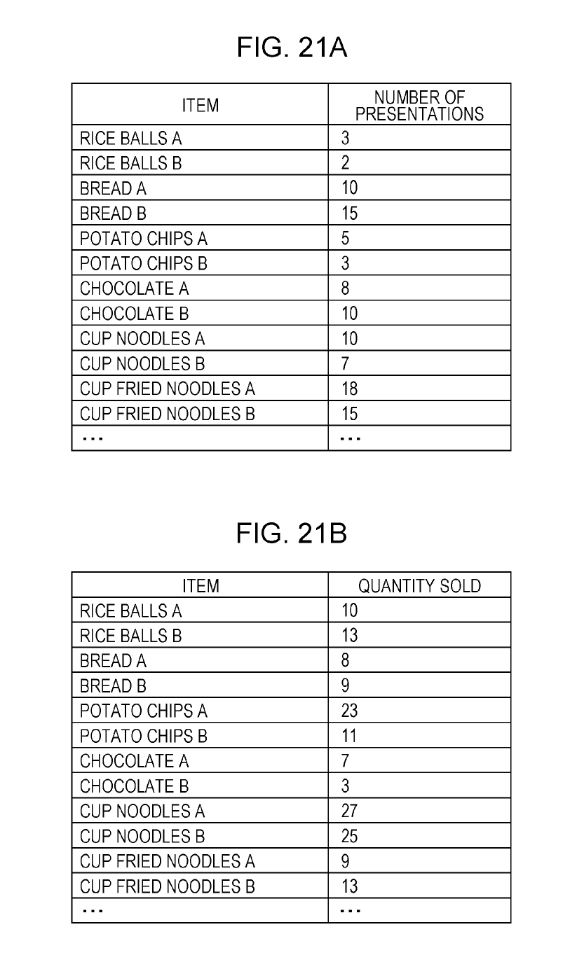

Referring to FIG. 21A, the presentation history database 250 stores a combination of a target item on which an item presentation has been performed for a predetermined period of time, and the item presentation. In the third embodiment, the predetermined period of time is one day, and the contents of the item presentation are cleared at fixed time, for example, at 12:00 a.m. midnight. For example, a record “item: bread A, and number of presentations: 10 times” indicates that the item presentation of bread A has been performed by 10 times since 12:00 a.m. midnight on the day.

### 3.3 Configuration and Operation of Presentation Section

The presentation section 500 is identical in configuration to the presentation section 300 except the following points. The presentation section 500 includes a presentation apparatus 530 with store digital signage 81 in place of the presentation apparatus 330, a presentation content determination unit 513 in place of the presentation content determination unit 313, and a presentation controller 520 in place of the presentation controller 320.

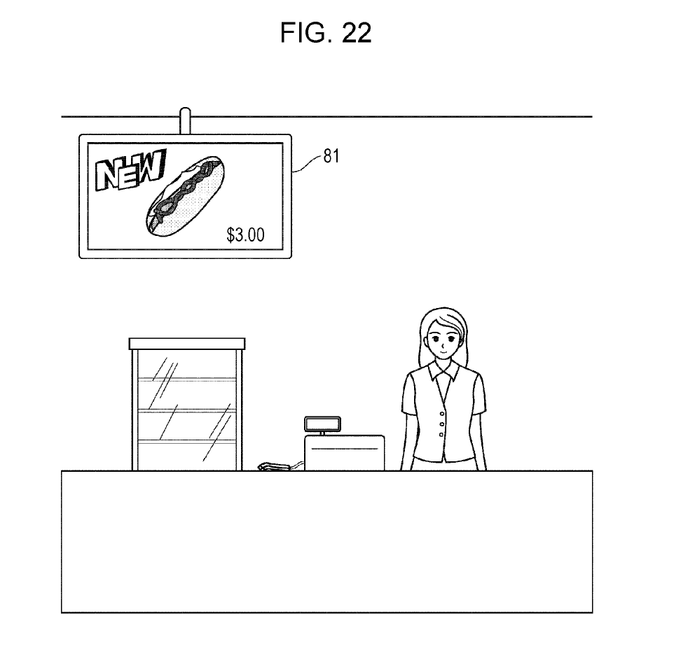

The store digital signage 81 is large-scale signage suspended from the ceiling right above a shop counter as illustrated in FIG. 22, and includes a liquid-crystal display as large as about 30 inches. The store digital signage 81 may be mounted on a wall surface rather than on the ceiling right above the shop counter. Alternatively, the digital signage 81 may be mounted on the front of an entrance of the store so that it is seen from the outside.

The presentation controller 520 as a media server is identical to the presentation controller 320 except that the presentation controller 520 has a function of reproducing a moving image on the store digital signage 81.

As the presentation content determination unit 313, the presentation content determination unit 513 performs the item presentation using the lighting device 41 and the digital signage 51. Each time the item presentation is performed, the presentation content determination unit 513 updates the number of item presentations performed for each item within a predetermined period stored on the presentation history database 250. The presentation content determination unit 513 determines an item whose signage moving image is to be reproduced on the digital signage 81, based on the number of item presentations performed for each item within the predetermined period, and then outputs the updated number of item presentations to the presentation controller 520. In a method of determining the item to be presented based on the number of item presentations performed for each item within the predetermined period, an order list may be produced in such a manner that items are selected in the order of from small to large number of presentations. In this way, this arrangement sets an item that is not presented on the product shelf to be widely appealing to all the customers in the store so that the customers may be interested in the item. For example, a list of a moving image of rice balls A, a moving image of potato chips B, . . . , may be produced based on the history of FIG. 21A.

### 3.4 Operations

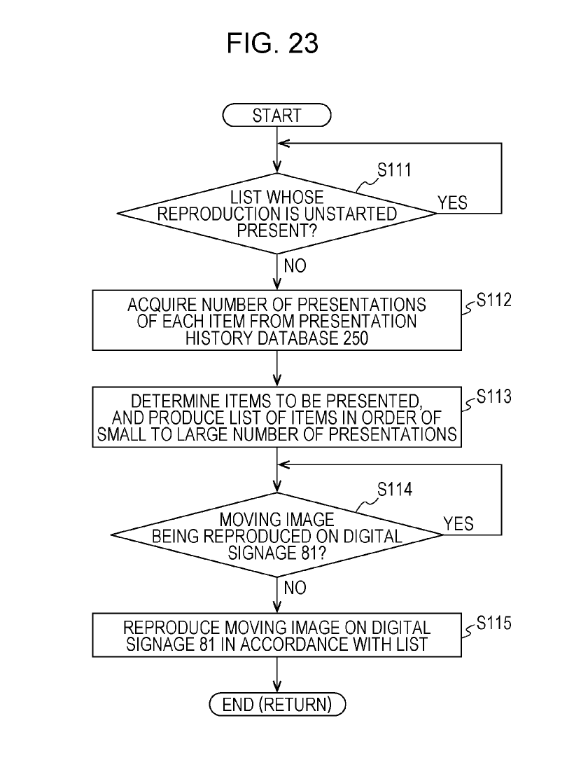

The operation of the item presentation of the item presentation using the lighting device 41 or the digital signage 51 in the third embodiment is identical from that of the first embodiment except that the presentation content determination unit 513 updates the number of presentations for each item within the predetermined period of time stored on the presentation history database 250 in S17. The discussion of the operation of the item presentation is thus omitted herein. The operation of the item presentation using the digital signage 81 is described with reference to FIG. 23.

The item presentation system determines whether the presentation content determination unit 513 stores a list whose reproduction has not yet started (S111). If the presentation content determination unit 513 has such a list (yes branch from S111), the item presentation system waits on standby for the reproduction of a first moving image.

If the presentation content determination unit 513 has no such list (no branch from S111), the presentation content determination unit 513 acquires the number of presentations for each item within the predetermined period of time from the presentation history database 250 (S112).

The presentation content determination unit 513 in the item presentation system produces a list of items to be presented on the digital signage 81, based on the number of presentations of each item within the predetermined period of time (S113). In the third embodiment, out of the items having 10 or smaller number of presentations, the list is made by listing up items in the order from smaller to larger number of presentations. For example, a list may include “rice balls B, potato chips B, rice balls A, potato chips A, cup noodles B, and chocolate A”. If multiple items have the same number of presentations, the order of the list may be in the order of acquisition or at random. The order of the list may be produced so that the same type of items may or may not consecutively appear.

The item presentation system determines whether a moving image is currently being reproduced on the digital signage 81 (S114). If a moving image is currently being reproduced on the digital signage 81 (yes branch from S114), the item presentation system waits until all the moving images in the list currently being reproduced have been reproduced.

If no moving image is currently being reproduced on the digital signage 81 (no branch from S114), the item presentation system reproduces a moving image on the digital signage 81 in accordance with the list produced in S113 (S115).

### 3.5 Summary

As described above, the item presentation system determines the item which is to be reproduced on the store digital signage, based on the information related to the number of item presentations performed on each item on the product shelf within the predetermined period of time. In this way, the item presentation system makes widely appealing an item which customers are not very much interested, or makes even more strongly appealing an item which customers are already interested in. An efficient advertisement is thus performed.

### Fourth Embodiment

In a fourth embodiment, the history of the item presentation is managed and checked.

Elements identical to those in the first through third embodiments are designated with the same reference numerals, operations identical to those in the first through third embodiments are designated with the same operation numbers, and the discussion thereof is omitted herein.

### 4.1 Configuration of Item Presentation System

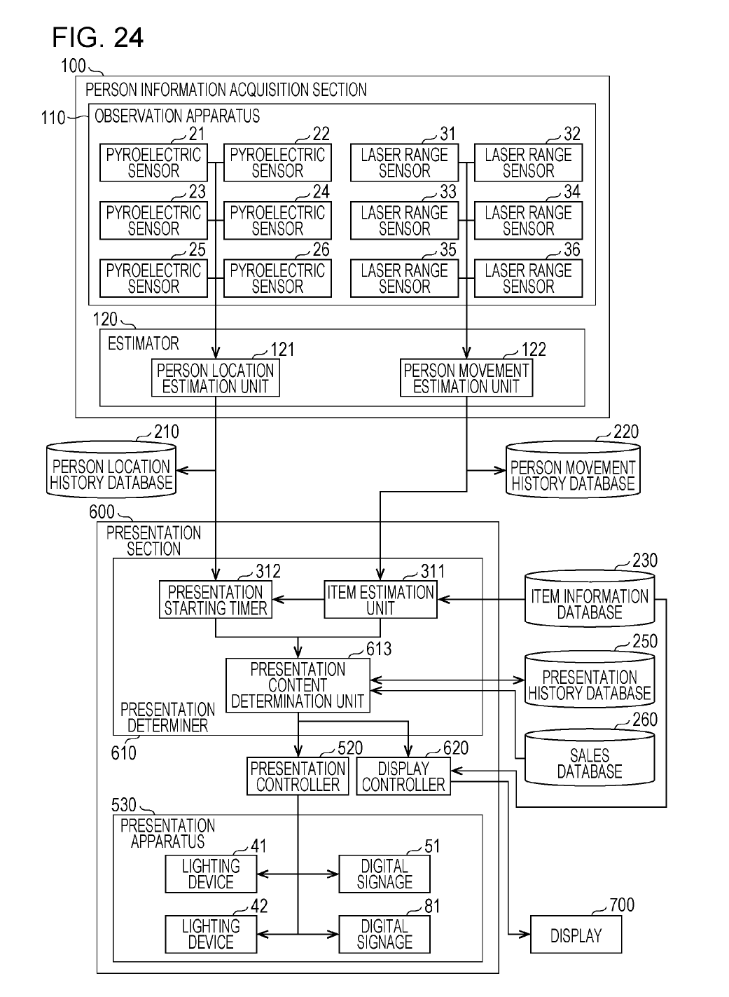

As illustrated in FIG. 24, the item presentation system of the fourth embodiment includes person information acquisition section 100, person location history database 210, person movement history database 220, item information database 230, presentation history database 250, sales database 260, presentation section 600, and display 700.

### 4.2 Sales Database

The sales database 260 is identical in hardware configuration to the other databases, and the discussion thereof is omitted. The contents of the sales database 260 are described below.

The sales database 260 stores information of items and the sales quantity of each item for a predetermined period of time as illustrated in FIG. 21B. In the fourth embodiment, the predetermined period of time is one day, and the information is cleared at fixed time, for example, at 12:00 a.m. midnight. For example, a record “item: bread A, and sales quantity: 8 times” indicates that eight loaves of bread A have been sold since 12:00 a.m. midnight on the day. The sales database 260 updates the contents thereof by acquiring the sales quantity of each item from a point of sale (POS) system every 10 minutes, for example.

### 4.3 Presentation Section

The presentation section 600 is identical in configuration to the presentation section 500 except that the presentation section 600 includes a presentation content determination unit 613 in place of the presentation content determination unit 513, and additionally a display controller 620.

As the presentation content determination unit 513, the presentation content determination unit 613 performs the item presentation in response to the movement of the customer, using the lighting device 41 or the digital signage 51. Each time the item presentation is performed, the presentation content determination unit 613 updates the number of item presentations of each item within the predetermined period of time stored on the presentation history database 250. The presentation content determination unit 613 determines an item whose signage moving image is to be reproduced on the store digital signage 81 based on the number of presentations and the sales quantity of each item within the predetermined period of time, and outputs the information of the determined item to the presentation controller 520. In a method of determining the item to be presented based on the number of presentations and the sales quantity of each item within the predetermined period of time, a list is made by listing items in the order of from high to low sales quantity on each number of presentations. The item presentation system thus makes an item whose presentation is presumed to be effective on the product shelf, more appealing to all the customers in the store. The item presentation system performs the advertisement, causing the customers to be more interested. For example, a list of “rice balls B, potato chips A, potato chips B, cup noodles B, . . . ” may be produced based on the history of FIG. 21A and FIG. 21B. The presentation content determination unit 613 outputs to the display controller 620 the sales quantity and the number of presentations of each item within the predetermined period.

The display controller 620 receives from the presentation content determination unit 613 the sales quantity and the number of presentations of each item within the predetermined period of time, aggregates the sales quantities and the number of presentations on a per product shelf using the item information database 230, and outputs the aggregate data to the display 700.

### 4.4 Display

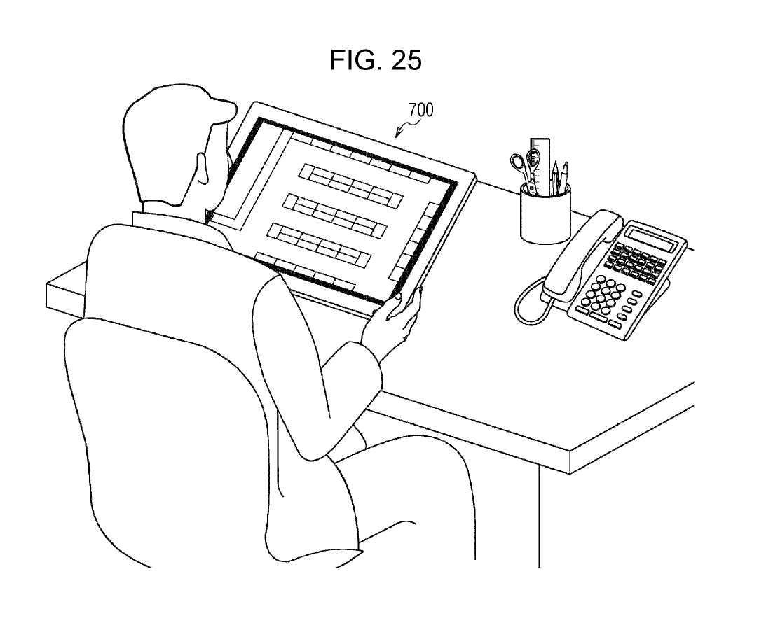

The display 700 is a tablet terminal having a touchpanel as large as about 10 inches as illustrated in FIG. 25. Touching on a screen of the display 700 means a selection of an icon.

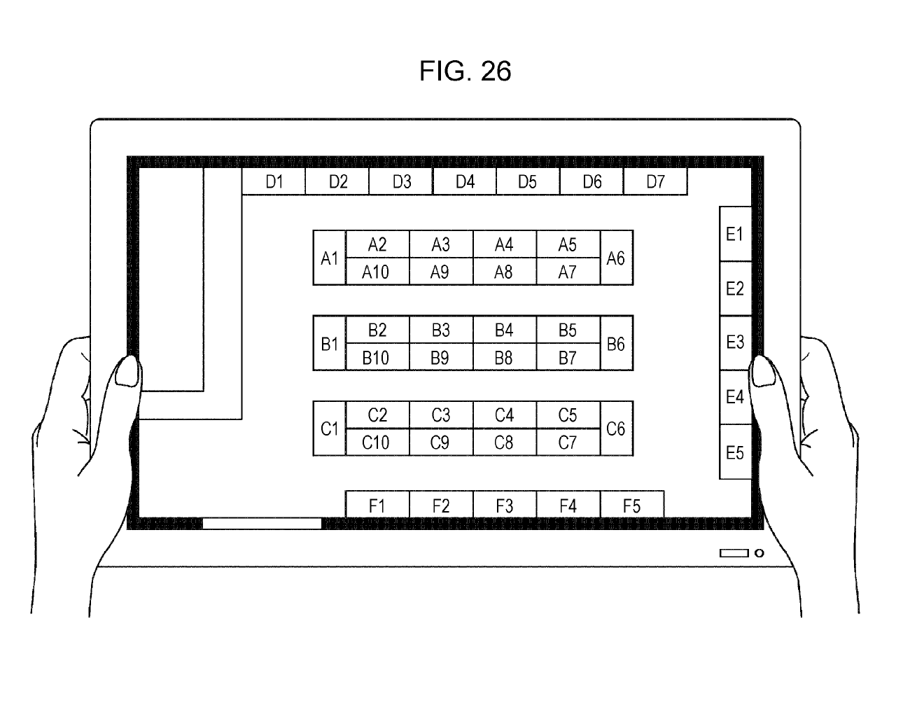

FIG. 26 illustrates a standard screen. The screen indicates the layout of the product shelves in the store. A1, . . . , and C8, and the like respectively illustrate product shelves and IDs thereof.

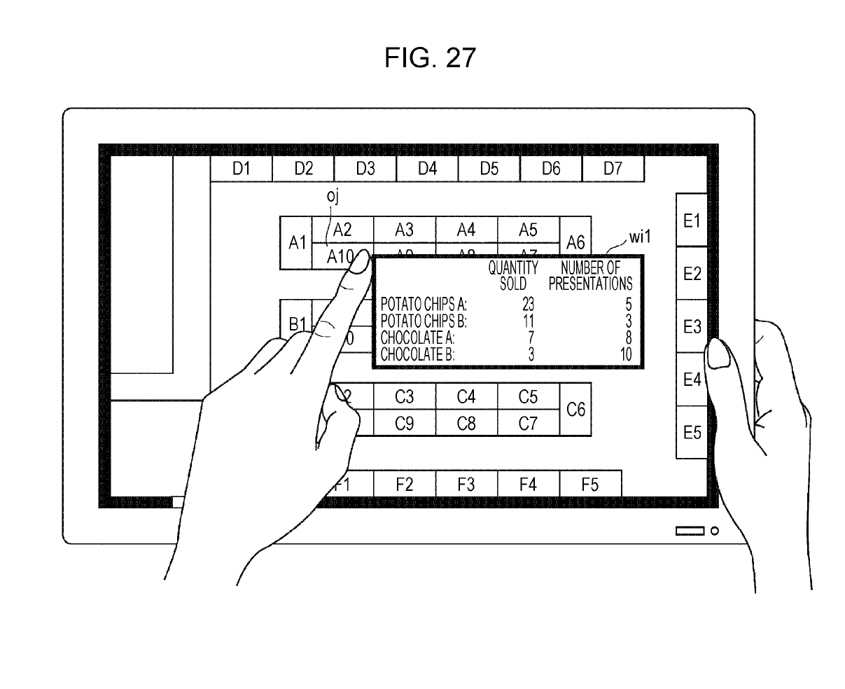

If the screen is touched, the display 700 determines the project shelf whose occupation region oj includes the touched location. If the touched location is included in the occupation region oj of a project shelf, the display 700 acquires from the presentation content determination unit 613 the sales quantity and the number of presentations of each item within the predetermined period of time on the items belonging to the product shelf. As illustrated in FIG. 27, the display 700 displays as a floating window wi1, the sales quantity and the number of presentations of each item within the predetermined period of time of the items displayed on the product shelf.

### 4.5 Summary

The item presentation system uses the sales quantity and the number of presentations on the product shelf in the item presentation on the store digital signage, with respect to each of the items on each product shelf, and displays these pieces of information in association with each other. The effectiveness of the item presentation on the product shelf is thus learned. The item presentation system easily determines whether the item presentation is effective or not. Effective advertisement activity may be performed by reviewing an item presentation having low effectiveness, and by using a highly effective item presentation as a reference when the item presentation is reviewed.

### Fifth Embodiment

A fifth embodiment supports processing big data of observation information and sales information. To support the big data in the fifth embodiment, the observation information is distributed for storage on a cloud network and the cloud server starts up an application for person movement estimation and an application for presentation content determination.

In the cloud server, a hypervisor loads and starts up an instance of an operating system in response to the load of the network and user access. Scalability is supported even if the observation information and the number of users requesting access excessively increase.

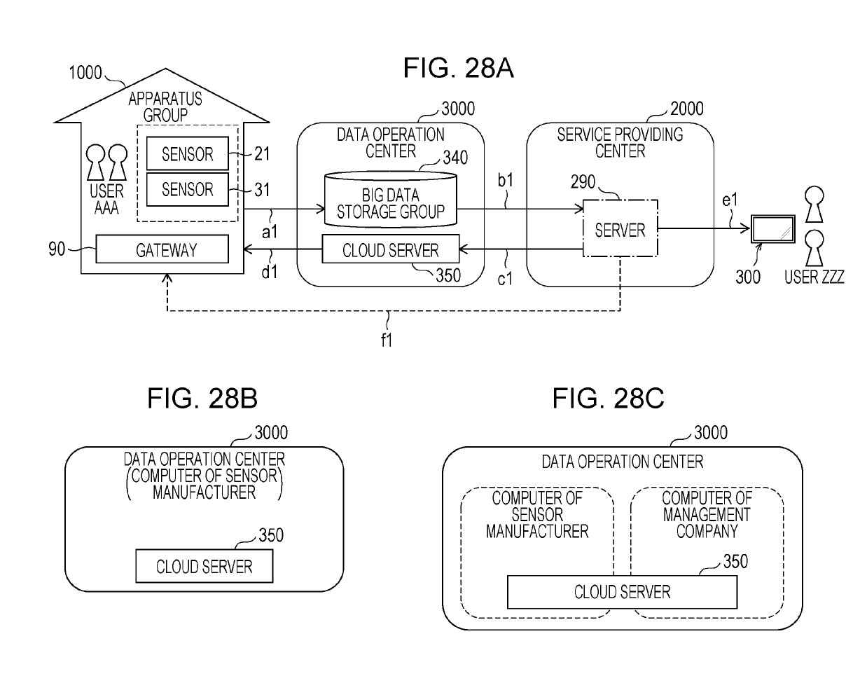

FIG. 28A illustrates a computer system (item presentation system) configured to perform the item presentation. The computer system as an information providing system implements the item presentation in the store. The information providing system includes a plurality of apparatus groups 1000 (including a gateway 90, sensors 21, 31, . . . ), a data operation center 3000 (including a cloud server 350, and a big data storage group 340), a service providing center 2000 (including a server 290), and a presentation section 300.

The apparatus group 1000 is a in-store network, includes a set of apparatuses arranged within a store, and includes the gateway 90, and the sensors 21, 31, . . . .

The service providing center 2000 serves as a window to a person who receives services. The service providing center 2000 receives an access request specifying a uniform resource locator (URL), and manages data directly related to the store operation of a user. The data management includes a user registration. In the user registration, a registration request is received from a user when a store is newly opened, and the user who has completed the registration is managed as a member of an item presentation service. The user registration includes a registration of store information serving as a target of the item presentation, and a member registration for a user to become a member of the item presentation service. The service providing center 2000 manages the store information thus registered and the registration information of the user entered in the member registration. The server 290 serves as a computer forming the service providing center 2000. The server 290 is represented by dot-dash line because there may be cases in which the service providing center 2000 does not include the server 290. For example, if the cloud server 350 manages all the data, the server 290 becomes unnecessary.

The data operation center 3000 is a business entity that performs a job of the service providing center from behind. The data operation center 3000 is not limited to a company that performs the data management and operates the cloud server 350. If a device manufacturer developing and manufacturing the sensors 21 and 31 performs the data management and manages the cloud server 350, the computer of the device manufacturer corresponds to the data operation center 3000 (see FIG. 28B). The data operation center 3000 is not limited to a single company. If a device manufacturer and a management company perform the data management and operates the cloud server 350 in cooperation or in shared fashion, the computers of the two entities or the computer of one of the two entities correspond to the data operation center 3000 (see FIG. 28C). The management company may be a security firm or an electric utility.

The cloud server 350 is present within the data operation center 3000, and is a virtual server that accesses an in-house intranetwork installed in the data center operation company and the outside Internet without discrimination. The cloud server 350 manages the big data by cooperating with a variety of apparatuses via the Internet.

The big data storage group 340 includes a plurality of storages that store the big data in a distributed fashion. The big data in the fifth embodiment is the observation information that indicates the movement taken by the customer at each product shelf in each store.

The flow of information in the above-described service is described below. The sensors 21 and 31 in the apparatus group 1000 generate an observation information log each time the user movement is detected, and accumulate the observation information logs on the big data storage group 340 in the data operation center 3000 via the cloud server 350 (see an arrow labeled al). The observation information log indicates the movement taken by the customer around the product shelf detected by the sensors 21 and 31 mounted around the product shelf in the store. There are times when the observation information logs are accumulated on the gateway 90 and the gateway 90 transfers the logs to the cloud server 350.

The cloud server 350 in the data operation center 3000 supplies the accumulated observation information logs by a unit of data to the service providing center 2000. The unit of data is a unit by which the data operation company is able to accumulate and organized the information in order and then to provide the organized information to the service providing center 2000, or a unit requested by the service providing center 2000. The unit is typically a fixed unit of data, but may be varied depending on an amount of information to be provided.

The observation information log is stored on the server 290 in the service providing center 2000 via the storage of the cloud server 350 as appropriate (see an arrow labeled b1). The service providing center 2000 arranges the observation information log into information adapted to service for the user, and is then provided to the user. The user who receives the arranged information may be a user AAA who uses the presentation section 300 or may be an outside user who uses the display 700. In a service providing method for the user, service providing routes indicated by arrows labeled f1 and e1 may also be used.

In the service providing method for the user, service providing routes indicated by arrows labeled c1 and d1 may be used. More specifically, the service is provided via the cloud server 350 in the data operation center 3000. The cloud server 350 in the data operation center 3000 has a function of arranging the observation information log into a form adapted to the service for the user. The service providing center 2000 may provide information obtained through such an arrangement function.

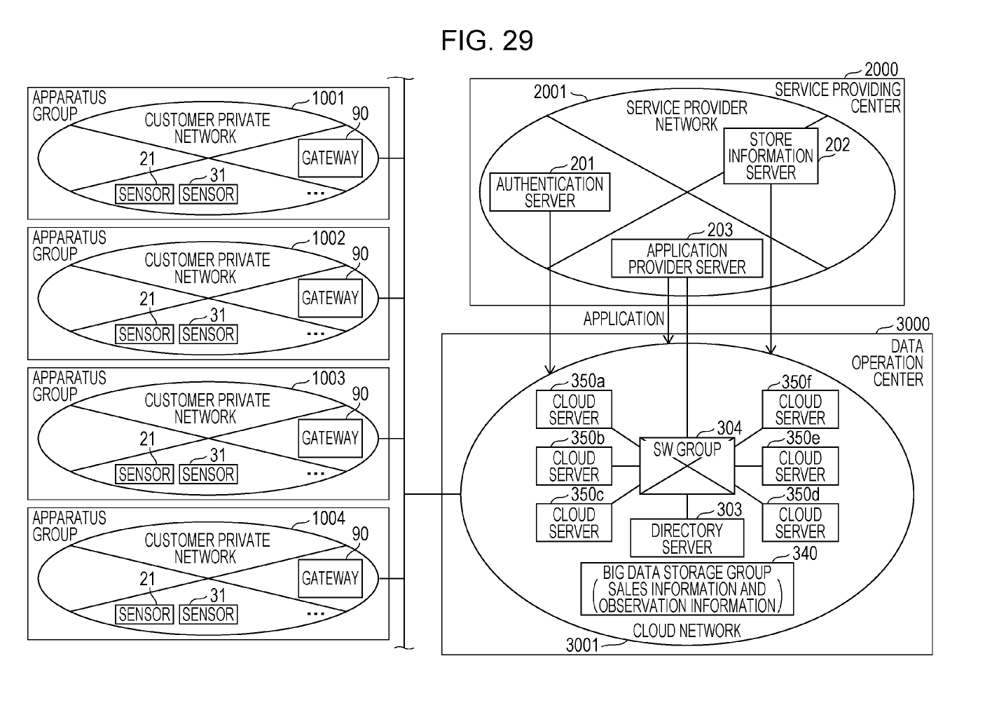

FIG. 29 illustrates a network configuration of the information providing system. As illustrated in FIG. 29, the apparatus group includes customer private networks 1001, 1002, 1003, and 1004. FIG. 29 illustrates a cloud network 3001 as a specific form of the data operation center 3000 illustrated in FIG. 28A and a service provider network 2001 as a specific form of the service providing center 2000 illustrated in FIG. 28A.

Each of the elements in the customer private networks 1001 through 1004 as the apparatus group 1000 is designated with a reference numeral in 100s based on a reference numeral 1000 to differentiate the reference numeral from that of another network.

Each of the elements in the service providing center 2000 and the service provider network 2001 is designated with a reference numeral in 200s based on a reference numeral 2000 to differentiate the reference numeral from that of another network. Each of the elements in the data operation center 3000 and the cloud network 3001 is designated with a reference numeral in 300s based on a reference numeral 3000 to differentiate the reference numeral from that of another network.

The customer private networks 1001 through 1004 are private networks forming an apparatus group in the store for the customers of the information providing service. The customer private network 1001 includes the gateway 90, and the sensors 21, 31, . . . .

The service provider network 2001 is an intranetwork in the service providing center 2000. The service provider network 2001 includes an authentication server 201 that authenticates a user when an login operation of the user is received, a store information server 202 that manages store information of each store, and an application provider server 203 that provides an application for service providing.

The cloud network 3001 is a virtual local area network (ULAN) that is integrally handled with the service provider network 2001 by using an integrated elastic cloud computing (iEC2) architecture. The cloud network 3001 includes cloud servers 350a, 350b, 350c, 350d, 350e, and 350f, a big data storage group 340, a directory server 303 and a switch (SW) group 304. The directory server 303 manages the presence of an instance in the cloud network, and the presence of a switch connected to the cloud server by associating the presence of the instance, and the presence of the switch with a combination of an IP address and a MAC address of a process request source node and an IP address and a MAC address of a process request destination node. The switch group 304 is used to interconnect cloud servers. The configuration of the network has been described. An internal configuration of the cloud server serving as a core of the cloud network is described below.

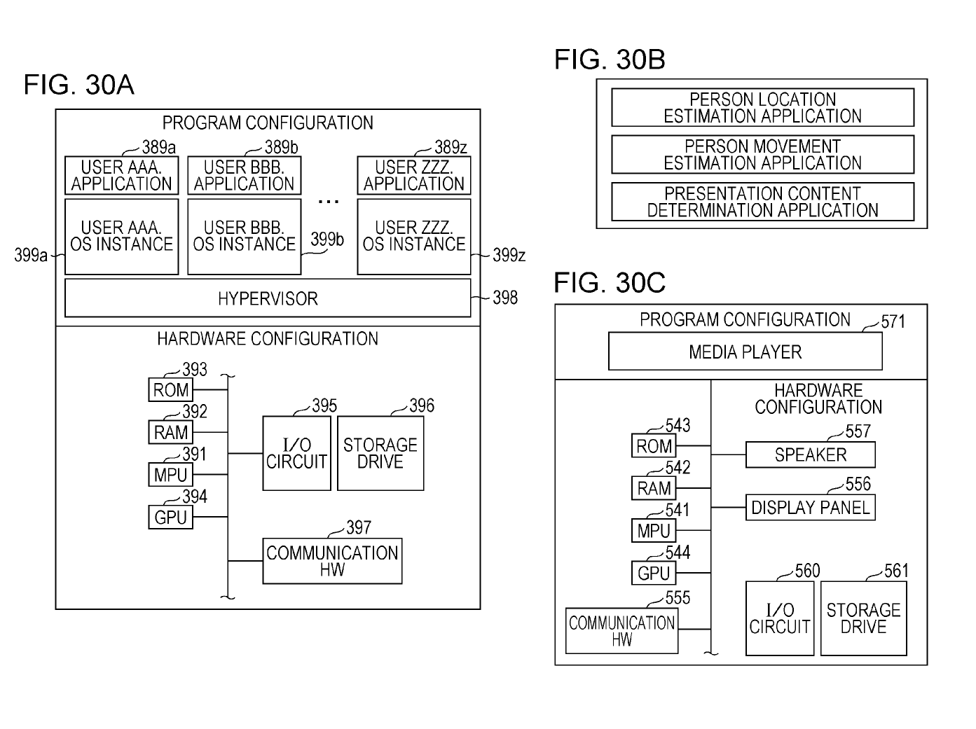

FIG. 30A illustrates an internal configuration of the cloud server. The cloud server in hardware configuration includes microprocessor unit (MPU) 391, random-access memory (RAM) 392, read-only memory (ROM) 393, graphic processor unit (GPU) 394, input/output (I/O) circuit 395, storage drive 396, and communication hardware (HW) 397.

The cloud server in program configuration includes hypervisor 398, operating system (OS) instances 399a, . . . , 399z (user AAA.OS instance, user BBB.OS instance, . . . , and user ZZZ.OS instance as illustrated in FIG. 30A), and applications 389a, 389b, . . . , and 389z (user AAA application, user BBB application, . . . , and user ZZZ application as illustrated in FIG. 30A). The hypervisor 398 monitors the OS, generates an OS instance in response to a request from a terminal, and manages the state of the OS instance. The operating system (OS) instances 399a, . . . , 399z are respectively generated for the login users by the hypervisor 398. The applications 389a, 389b, . . . , and 389z are started and controlled in state by the OS instances.

The user.OS instance is an instance of a library program responsible for a middleware process. Instances of the library program include an instance of a graphic rendering engine, an instance of an event module, an instance of a network file system, an instance of a kernel, and an instance of a protocol stack. The graphic rendering engine renders graphic user interface (GUI) such as a window or a menu in response to an application programming interface (API) call. The event module monitors an operation to the GUI and outputs an event indicating contents of the operation if the operation is detected. The network file system acquires a variety of files from a network drive or a local drive. The kernel manages the state of an application. The protocol stack executes a variety of protocols for server connection. In the cloud network, the function of the library program responsible for the middleware process is provided by the cloud server 350 rather than by the presentation section 300.

FIG. 30B illustrates an internal configuration of each application 389. The applications 389 include a person location estimation application to estimate the presence or absence of a customer in front of each product shelf, a person movement estimation application to estimate in each product shelf a location where the customer reaches out the hand to on each product shelf, and a presentation content determination application to determine the contents of the item presentation based on the estimation results.

FIG. 30C illustrates a hardware configuration of the presentation section 300 as an information terminal apparatus. The information terminal apparatus in hardware structure includes microprocessor unit (MPU) 541, random-access memory (RAM) 542, read-only memory (ROM) 543, graphic processor unit (GPU) 544, communication hardware 555, display panel 556, speaker 557, I/O circuit 560, and storage drive 561. In comparison with the hardware configuration of the cloud server, the hardware configuration of the presentation section 300 includes additionally the display panel 556 and the speaker 557 to perform the item presentation.

In comparison with the program configuration of the cloud server, the program configuration of the presentation section 300 has no layer corresponding to the operating system, and includes only the media player 571. The program of the media player 571 implements the process of the display panel 556 and the speaker 557 of the presentation section 300. The program configuration of the presentation section 300 includes only the media player 571 because the application performing a process related to the determination of the contents of the item presentation is loaded to the cloud server. A variety of processes using applications is performed by the user.OS instance on the cloud server. The presentation section 300 simply reproduces a moving image based on the process results of the user.OS instance. The media player 571 of the presentation section 300 receives a reproduction request event of the moving image from the application on the cloud server, and reproduces the moving image.

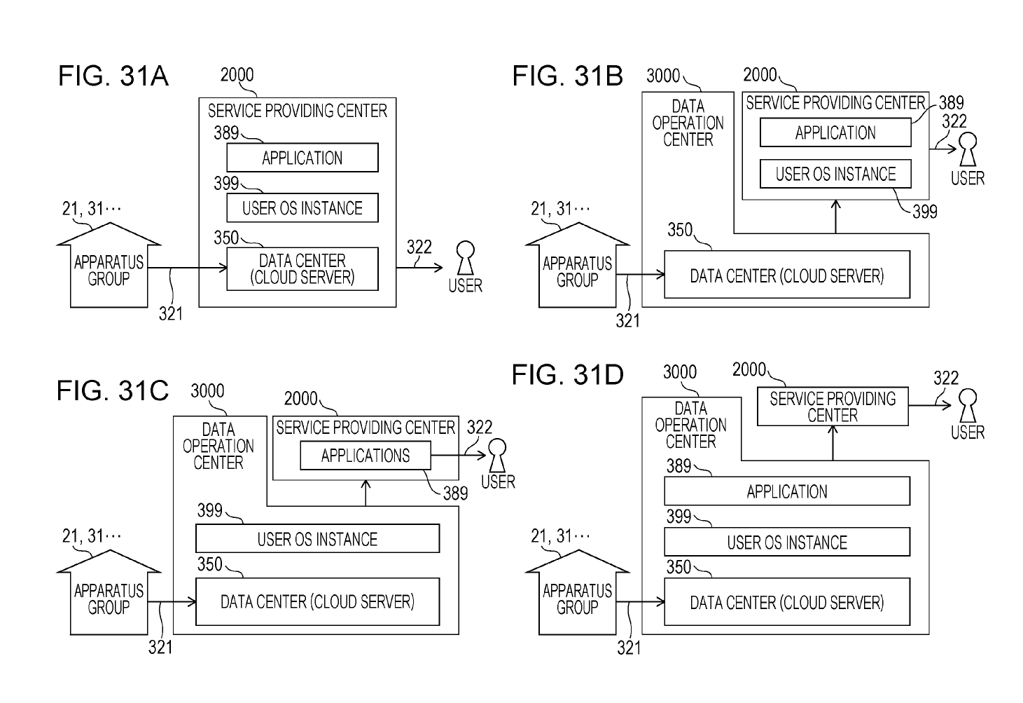

The presentation determiner 310 is connected to the server of the service provider network and includes the cloud server which is loaded with the person location estimation application, the person movement estimation application, and the presentation content determination application. Whether the application and the user OS instance are loaded to the service providing center 2000 or the data operation center 3000 may be varied as described with reference to FIG. 31A through FIG. 31D. FIG. 31A through FIG. 31D illustrate four cloud service types.

The following three points are common to the four cloud services of FIG. 31A through FIG. 31D. First, the application 389, and the user OS instance 399 are present on the could server of the data operation center 3000. Second, the apparatus group 1000 transmits the observation information log to the cloud server 350 of the data center as denoted by an arrow labeled 321. Third, the cloud server 350 of the data center supplies information to the presentation section 300 as denoted by an arrow labeled 322.

### First Service Type (In-House Data Center Type)

FIG. 31A illustrates a first service type (in-house data center type). In the first service type, the service providing center 2000 acquires information from the apparatus group 1000 and provides a service to the user. In the first service type, the service providing center 2000 functions as a data center operation company. More specifically, the service provider includes the cloud server 350 configured to manage big data. No data center operation company is thus present in the first service type.

In the first service type, the data center of the service providing center 2000 operates and manages the cloud server 350. The service providing center 2000 also manages the user OS instance 399 and the application 389. The service providing center 2000 provides service 322 using the user OS instance 399 and the application 389 managed by the service providing center 2000.

### Second Service Type (IaaS Based Type)

FIG. 31B illustrates a second service type (IaaS based type). IaaS stands for infrastructure as a service, and is a cloud service providing model in which an infrastructure where a computer system is constructed and operated is provided as a service over the Internet.

In the second service type, the data center operation company operates and manages the data center 350 (corresponding to the cloud server 350 herein). The service providing center 2000 manages the user OS instance 399 and the application 389. The service providing center 2000 provides the service 322 using the user OS instance 399 and the application 389 managed the service providing center 2000.

### Third Service Type (PaaS Based Type)

FIG. 31C illustrates a third service type (PaaS based type). PaaS stands for platform as a service, and is a cloud service providing model in which a platform serving as a base where software is constructed and operated is provided as a service over the Internet.

In the third service type, the data operation center 3000 manages the user OS instance 399, and operates and manages the data center 350 (corresponding to the cloud server 350). The service providing center 2000 manages the application 389. The service providing center 2000 provides the service 322 to the user using the user OS instance 399 managed by the data center operation company and the application 389 managed by the service providing center 2000.

### Fourth Service Type (SaaS Based Type)

FIG. 31D illustrates a fourth service type (SaaS based type). SaaS stands for software as a service, and is a cloud service model. The cloud service model has a function in which a company or an individual (user) having no data center (cloud server) may use via a network, such as the Internet, an application provided by a platform provider having a data center (cloud server).

In the fourth service type, the data operation center 3000 manages the application 389 and the user OS instance 399, and operates and manages the data center 350 (corresponding to the cloud server 350). The service providing center 2000 provides the service 322 to a user using the user OS instance 399 and the application 389 managed by the data operation center 3000.

In each of the service types, the service providing center 2000 performs a service providing action. The service provider or the data center operation company may develop the OS, the application or a database of big data, or may outsource the development of the OS, the application or the database of big data.

A communication sequence to collect and provide the observation information log via the cloud server is described below.

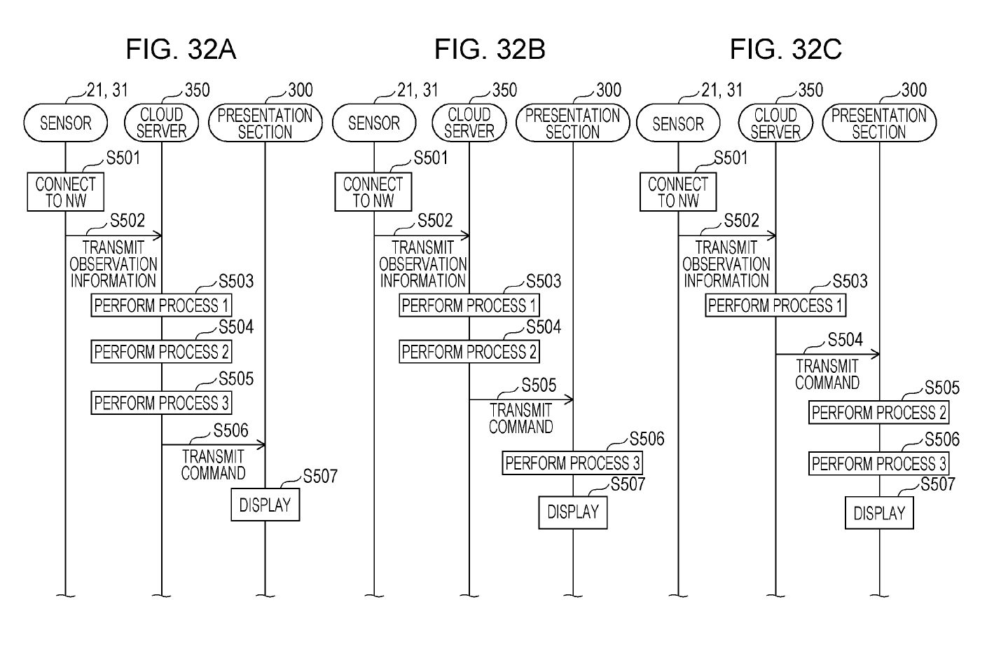

FIG. 32A illustrates the basic communication sequence between the cloud server 350 and the presentation section 300. As illustrated in FIG. 32A, the sensors 21 and 31 perform network connection (S501), and transmit the observation information log to the cloud server 350. The cloud server 350 performs processes 1 through 3. The process 1 (step S503), the process 2 (step S504), and the process 3 (step S505) represent the plurality of steps described with reference to the first embodiment. More specifically, the estimation of the person location is the process 1, the estimation of the person movement is the process 2, and the determination of the contents of the item presentation is the process 3.

Transmission of commands (S506) indicates the process results of the processes 1 through 3. The presentation section 300 displays data in response to the transmitted command (S507). FIG. 32B illustrates a variation of the operation of FIG. 32A. In the operation of FIG. 32B, the presentation section 300 performs the process 3, out of the processes 1 through 3 which are performed on the cloud server 350 in the operation of FIG. 32A. FIG. 32C illustrates another variation of the operation of FIG. 32A. In the operation of FIG. 32C, the presentation section 300 performs the processes 2 and 3, out of the processes 1 through 3 which are performed on the cloud server 350 in the operation of FIG. 32A.

In accordance with the fifth embodiment, the application corresponding to the estimator 120, and the application corresponding to the presentation determiner 310 are loaded onto the cloud server, and the item presentation operation is performed by estimating the movement of the customer on the cloud network. The moving image used in the item presentation is easily modified. A more appropriate instruction for the item presentation is generated by accumulating the presentation history. If a commercial intended for a particular region or a particular period of time has proved effective, the region or the time may be quickly expanded.

In the fifth embodiment, each of a private company network, a service provider network, and a cloud network is desirably includes a packet exchange network. In a virtual private network (VPN) constructed using a layer 3 protocol such as multi-protocol label switching (MPLS), the cloud network desirably includes a virtual stub identified by a common VLAN tag. In a customer private network, a network node functioning as a router or a switch has desirably layer 3 communication capability that supports MPLS (L3MPLS), or layer 2 communication capability that supports Ethernet and virtual private LAN service (VPLS).

The cloud server in the fifth embodiment desirably implements auto-scaler. The auto-scaler performs performance monitoring, scaling management, and instance management. In the performance monitoring, performance data of a series of user OS instances is collected, and system performance is calculated based on a performance metric calculated from the collected performance data. Metrics indicating the mean value and response time of requests processed every second are generated. In the scaling management, whether to adjust resources in the cloud network is examined in response to an elastic request or an inelastic request. In the instance management, the auto-scaler is desirably connected to a series of server OS instances via secure plane connection at the data link layer, and manages the server OS instances generated in the cloud network. The cloud network in the fifth embodiment desirably includes a load balancer. The load balancer is connected to a series of server OS instances via secure plane connection at the data link layer, and distributes jobs among internal servers and/or among the series of user OS instances. The distribution operations include weighted round robin, least connection, and fastest response.

A vast amount of data is used in the fifth embodiment because a stock quantity on the product shelf and the number of hand reaching movements in many stores every day are managed. The auto-scaler and the load balancer vary the number of generations of user OS instances in response to a request from the presentation section 300 and the display 700. Even if an enormous stock quantity on the product shelf and a large number of hand reaching movements result in many stores, an appropriate presentation instruction responsive to history is quickly transmitted to the presentation section 300.

### Modifications of Embodiments

### Modification 1

In the first through fourth embodiments, the person location history database 210, the person movement history database 220, and the item information database 230 are databases of a single store. The disclosure is not limited to this arrangement. For example, the person location history database 210, the person movement history database 220, and the item information database 230 may be shared by a plurality of stores. In such a case, each of the embodiments is implemented by including an identification, identifying which store's information, in the record of each of the person location history database 210 and the person movement history database 220 and by storing the product shelf ID and the placement area on a store basis on the item information database 230.

### Modification 2

In the second through fourth embodiments, the related item database 240, the presentation history database 250, and the sales database 260 are databases of a single store. The disclosure is not limited to this arrangement. For example, the related item database 240 may be shared among a plurality of stores. In such a case, the presentation content determination unit 413 may determine whether an acquired related item is displayed on the store based on the record on the item information database 230. Alternatively, the presentation history database 250, and the sales database 260 may be shared by a plurality of stores which are similar in terms of conditions of a location, for example, in the same region or same customer layer. An item as a target presented on the digital signage 81 may be determined using the history and the sales quantity of each item over all the stores. In this way, the database is aggregated and a wide range of merchandizing is achieved across the stores.

### Modification 3

In the first through fourth embodiments, the person location estimation unit 121 outputs the information related to the presence or absence of a customer in front of each product shelf, and the shelf ID together with time information every second. The disclosure is not limited to this arrangement. For example, the person location estimation unit 121 may output the information related to the presence or absence of a customer in front of each product shelf, and the shelf ID together with time information every three seconds. Alternatively, the person location estimation unit 121 may output the information related to the presence or absence of a customer in front of each product shelf, and the shelf ID together with time information only when a state with a person presumed to be present transitions to a state with no person presumed to be present, or only when a state with no person presumed to be present transitions to a state with a person presumed to be present. In this way, the presentation starting timer 312 is free from managing data related to the presence or absence of a person. Similarly, the person movement estimation unit 122 may simply output the location of the hand only when the detected location of the hand is effective.

### Modification 4

In the first through fourth embodiments, the presentation starting timer 312 starts the timer operation if the second movement is detected after the first movement is detected. When the timer operation is complete, the presentation starting timer 312 outputs the notification that the timer operation is complete. The disclosure is not limited to this arrangement. For example, the presentation starting timer 312 may receive a log responsive to the first movement from the person location history database 210, and then receives from the person movement history database 220 a log responsive to the second movement that happens later than the first movement. The presentation starting timer 312 then starts the timer operation in response to the time of the second movement included in the log. The detection operation of the third movement may not be performed until the end of the timer operation. If there is no log corresponding to the third movement after the completion of the timer operation, the presentation starting timer 312 determines that the timer operation is complete, and then outputs the notification that the timer operation is complete. If there is a log corresponding to the third movement, the third movement is presumed to have occurred. In this way, the timer operation is virtually performed.

### Modification 5

In the first through fourth embodiments, if a customer reaches out the hand to the same product shelf while the presentation starting timer 312 is operating, the item estimation unit 311 estimates a corresponding item, and the presentation starting timer 312 determines whether the corresponding item is the same item as the item in the timer operation. The disclosure is not limited to this arrangement. For example, if the customer reaches out the hand to the same product shelf while the presentation starting timer 312 is operating, the presentation starting timer 312 may default to zero and restart the timer operation. If the customer reaches out the hand to the same item in the first, third, and fourth embodiments, the presentation starting timer 312 simply operates in response to the last hand reaching movement. If the customer reaches out the hand to the same item in the second embodiment, the item presentation is performed without waiting for the completion of the timer operation. Defaulting to zero in the presentation starting timer 312 does not affect the operation. Since the presentation starting timer 312 is thus free from storing the information of the item at the start of the timer operation, the configuration of the system is simplified.

### Modification 6

In the third and fourth embodiments, in the method of selecting an item whose moving image is to be reproduced on the digital signage 81, items are selected in the order of from small to large number of item presentations within the predetermine period of time or in the order of from large to small ratio of sales quantity to the number of item presentations within the predetermined period of time. The disclosure is not limited to this arrangement. For example, items may be selected in the order of from large to small number of item presentations within the predetermine period of time or in the order of from small to large ratio of sales quantity to the number of item presentations within the predetermined period of time. Alternatively, items may be selected in the order of large to small sales quantity within the predetermined period of time or in the order of small to large sales quantity within the predetermined period of time.

The predetermined period of time is not limited within the same day. The predetermined period of time may be three days, a week, or two weeks. The predetermined period of time may be one day or a week from the time of reproduction of the moving image.

### Modification 7

In the third and fourth embodiments, the contents of the presentation history database 250 and the sales database 260 are erased at 12:00 a.m. midnight. The disclosure is not limited to this arrangement. The contents of the presentation history database 250 and the sales database 260 may be erased at 2:00 a.m. in the morning every day, or at a given time every week, for example, at 2:00 a.m. in the morning every Monday. The presentation history database 250 may store a combination of an item and time at which the item is presented, and may supply to the presentation content determination unit 513 or the presentation content determination unit 613 combinations of items and the number of presentations of the items during recent 24 hours. In such a case, the presentation history database 250 periodically erases records whose item presentations were performed 24 hours or before, or erases the records on an oldest first basis if the number of records exceeds a predetermined number. An excessive number of records is thus controlled.

### Modification 8

In the first through fifth embodiments, the sensor 21 is used to determine whether a customer is present in front of a product shelf. The disclosure is not limited to this arrangement. The pyroelectric sensor may be replaced with a human sensor. For example, an image analyzing apparatus and a monitoring camera mounted at each passage may be used to determine which product shelf a customer is in front of. This arrangement eliminates the need to mount the pyroelectric sensors at all the product shelves. Similarly, the laser range sensor 31 may be replaced with another position fixing sensor. An image analyzing apparatus and a monitoring camera mounted at each passage may be used to determine the location of the hand of a customer. In this way, the number of sensors is reduced. If a single monitoring camera is used to detect the presence of a customer is in front of a product shelf and the location where the customer reaches out the hand to, the number devices in the observation apparatus 110 is reduced.

### Modification 9

In the second embodiment, the presentation of the particular item or the presentation of the related item is performed on the digital signage 51. The disclosure is not limited to this arrangement. For example, the presentation of the particular item and/or the presentation of the related item may be performed on the lighting device 41. If the person movement estimation unit 122 has detected the fifth movement (yes branch from S21), the operation from no branch from S21 continues. For example, the item presentation of the related item is performed on the digital signage 51. When the presentation starting timer 312 completes the timer operation, the item presentation of the particular item may be performed on the lighting device 41. If the item presentation of the related item using the digital signage 51 is complete, the presentation of the particular item may be performed on the digital signage 51. Alternatively, the item presentation of the particular item may be performed at the same time when the item presentation of the related item is performed or immediately subsequent to the item presentation of the related item. This arrangement makes both the related item and the particular item appealing to the customer.

### Modification 10

In the first through fifth embodiments, the presentation starting timer 312 starts the timer operation in response to the detection of the second movement subsequent to the detection of the first movement. The disclosure is not limited to this arrangement. The presence of a person in front of a product shelf may be detected when the second movement is detected. The presentation starting timer 312 may start the timer operation in response to only the detection of the second movement on the premise that the detection of the second movement is regarded as the detection of the first movement.

### Modification 11

In the first through fifth embodiments, the person movement estimation unit 122 is ready to receive a signal from the laser range sensor 31 at any time. The disclosure is not limited to this arrangement. The person movement estimation unit 122 may detect the location of the hand only when the outputs from the pyroelectric sensor 21 and the person location estimation unit 121 indicate that a person is present in front of the product shelf. In this way, it is unnecessary for the laser range sensor 31 and the person movement estimation unit 122 to continuously operate. Power saving is thus achieved in the system.

### Modification 12

In the first through fifth embodiments, the predetermined period of time on the presentation starting timer 312 is 5 seconds. The disclosure is not limited to this arrangement. The predetermined period of time set on the presentation starting timer 312 may be set to be longer than a period from when the customer reaches out the hand to the item to when the customer moves away from the front of the product shelf without considering purchasing but shorter than a period from when the customer reaches out the hand to the item to when the customer moves away from the front of the product shelf after considering purchasing for a while.

### Modification 13

In the disclosure, the method described above may be implemented by a computer program, or a digital signal based on the computer program.

The disclosure includes computer readable recording media having recorded the computer program or the digital signal. The recording media include a flexible disk, a hard disk, a compact disk read-only memory (CD-ROM), a magneto-optical disk (MO), a digital versatile disk (DVD), a DVD-ROM, a DVD-RAM, a Blu-ray disk (BD), and a semiconductor memory. The disclosure also includes the digital signal recorded on one of these recording media.

The disclosure includes the computer program or the digital signal that is transmitted via an electronic communication line, a radio or wired communication line, a network, such as the Internet, or data broadcasting.

The disclosure includes a computer system including a microprocessor and a memory. The memory stores the computer program, and the microprocessor operates in accordance with the computer program.

The recording medium having the computer program or the digital signal recorded thereon is distributed to install the computer program or the digital signal onto another independent computer. The computer then executes the computer program. Alternatively, the computer program or the digital signal may be transmitted via the network to be installed onto the computer.

### Modification 14

The first through fifth embodiments have been discussed as examples of the disclosure. A variety of changes and modifications are possible without departing from the scope of the disclosure. For example, the second embodiment and third embodiment may be combined.

The disclosure further include the following embodiments.

The disclosure is related to an item presentation method in an item presentation system that detects a movement of a customer in a store, and that includes a presentation apparatus performing item presentation in the store based on detection results. The item presentation method includes detecting using a first detector a first movement indicating that the customer enters a predetermined area around a product shelf in the store, detecting using a second detector a second movement indicating that the customer reaches out one hand to a first item as one of the items displayed on the product shelf, starting to count time from a moment that the second movement is detected if the second movement is detected after the first movement is detected, causing the presentation apparatus to perform the item presentation on the item to which the customer reaches out the hand on the product shelf if the counted time becomes equal to a predetermined period of time, and causing the presentation apparatus not to perform the item presentation if a third movement indicating that the customer moves out of the predetermined area is detected before the counted time becomes equal to the predetermined period of time. In this configuration, the timer operation is not complete if a customer approaches a product shelf, and takes an item displayed on the product shelf, and soon moves away without the item. The item presentation is not performed on that customer. A customer having decided to purchase an item in advance may approach a product shelf, take the item in his or her hand, and then soon move away. The item presentation is omitted on such a customer, and excessively repeated item presentation is thus avoided. This reduces the possibility that the item presentation by lighting effect and signage becomes dull and monotonous to the customers. On the other hand, a customer may approach a product shelf, take an item from the product shelf, and look at the item for a while. In such a case, the item presentation is performed after the predetermined period of time elapse from the customer's hand reaching movement. A customer who takes an item and examines a package of the item may typically remain in front of the product shelf until the customer decides whether to purchase the item or not. It is thus presumed that the customer who remains in front of the product shelf after reaching out the hand to the item is interested in the item. The item presentation is performed on such a customer. In this way, the item presentation makes the item appealing to customers who are strongly interested in the item by narrowing the target range of the item presentation. Since the item presentation is aimed at customers who are interested in items in front of a product shelf but still undecided to purchase them, the effectiveness of the item presentation is increased.

In the item presentation method, the first movement may be detected by detecting that the customer approaches the product shelf. The second movement may be detected by detecting a location where the customer reaches out the hand.

In this way, the item presentation system may easily detect whether a customer is present within the particular area and which item on the product shelf the customer reaches out the hand to.

In the item presentation method, a plurality of items are respectively displayed in a plurality of product storage bins horizontally arranged on the product shelf. The item presentation system is connected to a product shelf information database. The product shelf information database stores location information indicates a location of each product storage bin and an item information may indicate item displayed at the location of the product storage bin. The first item is identified using the location information and the item information.

In this way, the item presentation system detects which item bin the customer has reached the hand.

In the item presentation method, the second detector may comprise a phase-detection distance sensor, and detects using coordinates of a rectangular coordinate system a location where the customer reaches out the hand, the rectangular coordinate system having the first reference axis in the direction of height of the product shelf, and the second reference axis in the direction of width of the product shelf.

In this way, the product shelf is two-dimensionally defined in the direction of height and the direction of width, and data to be stored the product shelf information database is simplified. The item presentation system reliably detects which item's bin the customer reaches out the hand to.

In the item presentation method, the second detector may comprise a monitoring camera that monitors a movement of the customer within a predetermined distance from the product shelf. The monitoring camera comprises an imaging circuit and an image recognition circuit that recognizes using a frame image captured by the imaging circuit the location where the customer reaches out the hand. The item presentation method may comprise determining coordinates (x, y) of the location where the customer reaches out the hand using a first rectangular coordinate system having a first reference axis in a direction of height of the frame image and a second reference axis in a direction of width of the frame image, and converting coordinates (x, y) of the location where the customer reaches out the hand into coordinates of a second rectangular coordinate system having a third reference axis in a direction of height of the product shelf and a fourth reference axis in a direction of width of the product shelf.

In this way, the product shelf is two-dimensionally defined in the direction of height and the direction of width, and data to be stored on the product shelf information database is simplified. The item presentation system reliably detects which item's bin the customer reaches out the hand.

In the item presentation method, the presentation apparatus may comprise a light mounted on the product shelf, and the item presentation may comprise lighting of the light mounted on the product shelf to which the customer reaches out the hand, by changing a color of the light, or by changing brightness of the light. In this way, the item is set to be appealing to customers by visibly changing the appearance of the particular product shelf and the bin of the particular product shelf.

In the item presentation method, the presentation apparatus may comprise lights mounted on a ceiling of the store, and the item presentation may comprise lighting, from among the lights mounted on the ceiling of the store, of a light corresponding to the product shelf to which the customer reaches out the hand, by changing a color of the light, or by changing brightness of the light.

In the item presentation method, the presentation apparatus may comprise first digital signage that is mounted on the product shelf and that reproduces an advertisement. The item presentation may comprise reproducing of the advertisement of the first item by the first digital signage.

In the item presentation method, the item presentation system may be connected to a related item database, and the related item database stores item information concerning a second item related to the first item in the store. The item presentation method may comprise identifying the second item related to the first item using the related item database, and performing the item presentation on the identified related second item if the second movement is detected during the counting of the time.

In the item presentation method, the presentation apparatus may comprise first digital signage that is mounted on the product shelf where the identified second item is displayed, and that reproduces an advertisement. The item presentation may comprise reproducing of the advertisement of the identified second item by the first digital signage.

In the item presentation method, the item presentation system may comprise a second digital signage. The item presentation system is connected to a presentation history database that stores information of an item corresponding to a target of the item presentation, together with time and date at which the item presentation is performed. The item presentation method may comprise identifying an item having a highest number of item presentations performed during a predetermined period of time, using the presentation history database, and causing the second digital signage to reproduce the advertisement of the identified item.

This arrangement makes an item, in which a customer is interested, appealing to other customers who are not present in front of the display product shelf.

In the item presentation method, the item presentation system may comprise second digital signage. The item presentation system is connected to a presentation history database that stores information of an item corresponding to a target of the item presentation, together with time and date at which the item presentation is performed. The item presentation method may comprise identifying an advertisement of an item having a lowest number of item presentations performed during a predetermined period of time, using the presentation history database, and causing the second digital signage to reproduce the advertisement of the identified item.

This arrangement makes an item appealing to customers who are in the store but not in front of the product shelf of the item.

In the item presentation method, the item presentation system may comprise second digital signage. The item presentation system is connected to a presentation history database and a sales database, the presentation history database storing information of an item corresponding to a target of the item presentation, together with time and date at which the item presentation is performed, and the sales database storing sales information related to a sales quantity of each item at regular intervals. The item presentation method may comprise identifying an item having a lowest ratio of the sales quantity to the number of item presentations performed during a predetermined period of time using the presentation history database and the sales database, and causing the second digital signage to reproduce the advertisement of the identified item.

There may be some items that are simply looked at by many customers. Customers who are really interested in those items may not happen to come to the corresponding product shelf. In such a case, this arrangement makes the items appealing so that the interested customers may take the item in their hands.

In the item presentation method, the item presentation system may comprise second digital signage. The item presentation system is connected to a presentation history database and a sales database, the presentation history database storing information of an item becoming a target of the item presentation, together with time and date at which the item presentation is performed, and the sales database storing sales information related to a sales quantity of each item at regular intervals. The item presentation method may comprise identifying an item having a highest ratio of the sales quantity to the number of item presentations performed during a predetermined period of time using the presentation history database and the sales database, and causing the second digital signage to reproduce the advertisement of the identified item.

This arrangement sets an item having a high purchase rate among the customers who have taken the item in their hands to be appealing to other customers in the store so that they may really take the item in their hands.

In the item presentation method, if a fourth movement indicating that the customer reaches out the hand to a second item is detected during the counting of the time, a type of the second item being different from a type of the first item, it may be restarted counting the time from a moment that the fourth movement is detected.

In the item presentation method, if a fifth movement indicating that the customer reaches out the hand to a third item different from the first item is detected during the counting of the time, a type of the third item being identical to a type of the first item, it may be restarted counting the time from a moment that the fifth movement is detected.

The disclosure is related to an information display method that detects a movement of a customer in a store, and that performs item presentation in the store based on detection results, the item presentation system including a display terminal. The information display method includes detecting using a first detector a first movement indicating that a customer enters a predetermined area around a product shelf, detecting using a second detector a second movement indicating that the customer reaches out one hand to a first item as one of the items displayed on the product shelf, starting to count time from a moment that the second movement is detected if the second movement is detected after the first movement is detected, and stopping the counting of the time if a third movement indicating that the customer moves out of the predetermined area is detected before the counted time becomes equal to a predetermined period of time. The display terminal displays a number of times to each item by which the customer reaches out the hand to the item within a predetermined duration of time. In the information display method, the trend of customers interested in an item but undecided to purchase the item is aggregated. The purchase intention of the customers is thus accurately sounded.

The technique of the disclosure is applicable to the advertisement activity in a store. Sharing the database among a plurality of stores improves the accuracy of merchandising, and store opening based on a franchise agreement becomes possible.

What is claimed is:

1. An item presentation method in an item presentation system that detects a movement of a customer in a store, and that includes a presentation apparatus performing item presentation in the store based on detection results, the item presentation method comprising:
detecting using a first detector a first movement indicating that the customer enters a predetermined area around a product shelf in the store;
detecting using a second detector a second movement indicating that the customer reaches out one hand to a first item as one of the items displayed on the product shelf;
starting to count time from a moment that the second movement is detected if the second movement is detected after the first movement is detected;
causing the presentation apparatus to perform the item presentation on the item to which the customer reaches out the hand on the product shelf if the counted time becomes equal to a predetermined period of time; and
causing the presentation apparatus not to perform the item presentation if a third movement indicating that the customer moves out of the predetermined area is detected before the counted time becomes equal to the predetermined period of time.

2. The item presentation method according to claim 1, wherein
the first movement is detected by detecting that the customer approaches the product shelf, and
wherein the second movement is detected by detecting a location where the customer reaches out the hand.

3. The item presentation method according to claim 1, wherein
the first detector is identical to the second detector.

4. The item presentation method according to claim 2,
wherein a plurality of items are respectively displayed in a plurality of product storage bins horizontally arranged on the product shelf,
wherein the item presentation system is connected to a product shelf information database,
wherein the product shelf information database stores location information indicating a location of each product storage bin and an item information indicating item displayed at the location of the product storage bin, and
wherein the first item is identified using the location information and the item information.

5. The item presentation method according to claim 4, wherein the second detector comprises a phase-detection distance sensor, and detects using coordinates of a rectangular coordinate system a location where the customer reaches out the hand, the rectangular coordinate system having the first reference axis in the direction of height of the product shelf, and the second reference axis in the direction of width of the product shelf.

6. The item presentation method according to claim 4, wherein the second detector comprises a monitoring camera that monitors a movement of the customer within a predetermined distance from the product shelf,
wherein the monitoring camera comprises an imaging circuit and an image recognition circuit that recognizes using a frame image captured by the imaging circuit the location where the customer reaches out the hand,
the item presentation method further comprises:
determining coordinates (x, y) of the location where the customer reaches out the hand using a first rectangular coordinate system having a first reference axis in a direction of height of the frame image and a second reference axis in a direction of width of the frame image, and
converting coordinates (x, y) of the location where the customer reaches out the hand into coordinates of a second rectangular coordinate system having a third reference axis in a direction of height of the product shelf and a fourth reference axis in a direction of width of the product shelf.

7. The item presentation method according to claim 1, wherein the presentation apparatus comprises a light mounted on the product shelf, and the item presentation comprises lighting of the light mounted on the product shelf to which the customer reaches out the hand, by changing a color of the light, or by changing brightness of the light.

8. The item presentation method according to claim 1, wherein the presentation apparatus comprises lights mounted on a ceiling of the store, and the item presentation comprises lighting, from among the lights mounted on the ceiling of the store, of a light corresponding to the product shelf to which the customer reaches out the hand, by changing a color of the light, or by changing brightness of the light.

9. The item presentation method according to claim 1, wherein the presentation apparatus comprises first digital signage that is mounted on the product shelf and that reproduces an advertisement, and
wherein the item presentation comprises reproducing of the advertisement of the first item by the first digital signage.

10. The item presentation method according to claim 1, wherein the item presentation system is connected to a related item database, and the related item database stores item information concerning a second item related to the first item in the store, and
the item presentation method further comprising:
identifying the second item related to the first item using the related item database; and
performing the item presentation on the identified related second item if the second movement is detected during the counting of the time.

11. The item presentation method according to claim 10, wherein the presentation apparatus comprises first digital signage that is mounted on the product shelf where the identified second item is displayed, and that reproduces an advertisement, and
wherein the item presentation comprises reproducing of the advertisement of the identified second item by the first digital signage.

12. The item presentation method according to claim 1, wherein the item presentation system comprises a second digital signage,
wherein the item presentation system is connected to a presentation history database that stores information of an item corresponding to a target of the item presentation, together with time and date at which the item presentation is performed,
the item presentation method further comprising:
identifying an item having a highest number of item presentations performed during a predetermined period of time, using the presentation history database; and
causing the second digital signage to reproduce the advertisement of the identified item.

13. The item presentation method according to claim 1, wherein the item presentation system comprises second digital signage,
wherein the item presentation system is connected to a presentation history database that stores information of an item corresponding to a target of the item presentation, together with time and date at which the item presentation is performed,
the item presentation method further comprising:
identifying an advertisement of an item having a lowest number of item presentations performed during a predetermined period of time, using the presentation history database; and
causing the second digital signage to reproduce the advertisement of the identified item.

14. The item presentation method according to claim 1, wherein the item presentation system comprises second digital signage,
wherein the item presentation system is connected to a presentation history database and a sales database, the presentation history database storing information of an item corresponding to a target of the item presentation, together with time and date at which the item presentation is performed, and the sales database storing sales information related to a sales quantity of each item at regular intervals,
the item presentation method further comprising:
identifying an item having a lowest ratio of the sales quantity to the number of item presentations performed during a predetermined period of time using the presentation history database and the sales database; and
causing the second digital signage to reproduce the advertisement of the identified item.

15. The item presentation method according to claim 1, wherein the item presentation system comprises second digital signage,
wherein the item presentation system is connected to a presentation history database and a sales database, the presentation history database storing information of an item becoming a target of the item presentation, together with time and date at which the item presentation is performed, and the sales database storing sales information related to a sales quantity of each item at regular intervals,
the item presentation method further comprising:
identifying an item having a highest ratio of the sales quantity to the number of item presentations performed during a predetermined period of time using the presentation history database and the sales database; and
causing the second digital signage to reproduce the advertisement of the identified item.

16. The item presentation method according to claim 1, further comprising, if a fourth movement indicating that the customer reaches out the hand to a third item is detected during the counting of the time, a type of the third item being different from a type of the first item, restarting to count the time from a moment that the fourth movement is detected.

17. The item presentation method according to claim 1, further comprising, if a fifth movement indicating that the customer reaches out the hand to a fourth item different from the first item is detected during the counting of the time, a type of the fourth item being identical to a type of the first item, restarting to count the time from a moment that the fifth movement is detected.

18. An information display method of an item presentation system that detects a movement of a customer in a store, and that performs item presentation in the store based on detection results, the item presentation system including a display terminal, the information display method comprising:
detecting using a first detector a first movement indicating that a customer enters a predetermined area around a product shelf;
detecting using a second detector a second movement indicating that the customer reaches out one hand to a first item as one of the items displayed on the product shelf;
starting to count time from a moment that the second movement is detected if the second movement is detected after the first movement is detected; and
stopping the counting of the time if a third movement indicating that the customer moves out of the predetermined area is detected before the counted time becomes equal to a predetermined period of time,
wherein the display terminal displays a number of times to each item by which the customer reaches out the hand to the item within a predetermined duration of time.
